(19) United States
(12) Patent Application Publication
(10) Pub. No.: US 2002/0052841 A1
(43) Pub. Date: May 2, 2002

(54) Electronic payment system

(76) Inventors: Paul D. Guthrie, San Francisco, CA (US); Ronald G. Martinez, San Francisco, CA (US); Kimo Crossman, San Francisco, CA (US); Matthew Robert McEachen, El Granada, CA (US)

Correspondence Address: MARK J. SPOLYAR, 175 PERALTA AVE., SAN FRANCISCO, CA, 94110, US

(21) Appl. No.: 09/833,014

(22) Filed: Apr. 10, 2001

Related U.S. Application Data
(60) Provisional application No. 60/244,011, filed on Oct. 27, 2000.
(60) Provisional application No. 60/244,829, filed on Oct. 31, 2000.

(51) Int. Cl. G06F 17/60

(52) U.S. Cl. 705/40; 705/39; 235/379

(57) ABSTRACT

Methods, apparatuses and systems facilitating payments over a computer network. The on-line payment system of the present invention can be used to facilitate person-to-person payments, person-to-business payments, and business-to-business payments. In one embodiment, the on-line payment system of the present invention leverages the viral elements of on-line payment systems to market other financial services, such as credit and/or debit card services. Other embodiments provide efficient payment protocols reducing transaction costs and fees associated with such payments. Other embodiments of the invention allow users to transfer funds to other users with a telephone number.

### RELATED APPLICATION

The present application claims priority from U.S. Provisional Application No. 60/244,011, filed Oct. 27, 2000, and U.S. Provisional Application No. 60/244,829, filed Oct. 31, 2000.

### FIELD OF THE INVENTION

The present invention relates to electronic commerce and, more particularly, relates to methods and systems facilitating payments and other transactions over a computer network.

### BACKGROUND OF THE INVENTION

The emergence of the Internet has set off explosive growth in the provision of on-line services. Indeed, the Internet has quickly become a widely-used means for conducting transactions, such as banking and retail transactions. For example, during a typical on-line retail transaction, a consumer browses a merchant site and selects a product for purchase. The on-line merchant presents the consumer with a form into which the user enters data necessary to complete the transaction, such as name, shipping/billing address, and credit or debit card number. The consumer transmits the completed form to the on-line merchant, who processes the credit or debit card transaction. Such person-to-business transactions present relatively few technical problems, since most consumers posses a credit and/or debit card account and most on-line merchants have the ability to process credit card transactions. Rather, the main technical challenge is the protection of the consumer's credit or debit card account data, which is generally accomplished by well-known encryption techniques, such as the Secure Sockets Layer (SSL) encryption protocol. Another technical challenge is providing methods and systems that make on-line transactions more convenient for users. For example, electronic wallet services have been developed to perform form fill operations such that the consumer need not perform the mundane task of repeatedly entering credit card and other transaction data.

Other on-line services, such as on-line auctions, require the exchange of money between two individuals. Person-to-Person (P2P) transactions, however, present certain technical challenges that must be overcome, since it is cost-prohibitive for individuals to have the ability to accept and process credit or debit card transactions. As a result, P2P payment web sites have emerged to facilitate payments between individuals over a computer network. Most P2P payment systems allow users to transfer money to other users by providing a checking or credit card number and the intended recipient's e-mail address. In general, the P2P payment system debits the funds from the account specified by the user and deposits it in a settlement account. The system then notifies the intended recipient via e-mail that a payment is pending. The intended recipient generally logs in to the P2P payment system and provides a checking account number. The payment system then deposits the requisite funds from the payment system's settlement account into the intended recipient's checking account. In addition, certain P2P payment systems also allow users to request money from other users and receive payment in a similar manner. In fact, certain P2P payment systems feature special forms, tools and protocols (including escrow services) supporting on-line activities, such as auction payments or group billing.

While the on-line payment systems of the prior art fulfill their respective objectives, such prior art systems have only scratched the surface of the realm of possibilities. For example, and in an exemplary embodiment, the present invention allows a financial institution to leverage the viral qualities of an on-line payment system to market other financial services, such as a credit or debit card account. Other embodiments of the present invention extend the capabilities of electronic payment systems.

### SUMMARY OF THE INVENTION

The present invention provides methods, apparatuses and systems facilitating payments over a computer network. The on-line payment system of the present invention can be used to facilitate person-to-person payments, person-to-business payments, and business-to-business payments. In one embodiment, the on-line payment system of the present invention leverages the viral elements of on-line payment systems to market other financial services, such as credit and/or debit card services. Other embodiments provide efficient payment protocols reducing transaction costs and fees associated with such payments. Other embodiments of the invention allow users to transfer funds to other users with a telephone number.

### DESCRIPTION OF THE DRAWINGS

FIG. 1 is a functional block diagram illustrating the operating environment according to one embodiment of the present invention.

FIG. 2 is a functional block diagram setting forth an apparatus for facilitating transactions over a computer network.

FIG. 3 is a functional block diagram illustrating the flow of data according to a registration process involved in one embodiment of the present invention.

FIGS. 4 thru 11 are functional block diagrams illustrating payment work flows according to various embodiments of the present invention.

FIG. 12 illustrates the trust relationships between elements of user account data according to one embodiment of the risk management module of the present invention.

FIG. 13 is a flow chart diagram illustrating a payment operation according to one embodiment of the present invention.

FIG. 14 is a flow chart diagram providing another payment operation according to one embodiment of the present invention.

FIG. 15 is a flow chart diagram setting forth an additional payment operation according to one embodiment of the present invention.

FIG. 16 is a flow chart providing another payment operation according to one embodiment of the invention.

FIG. 17 is a flow chart diagram illustrating a method facilitating the prevention of user churn among client financial institutions.

### DESCRIPTION OF PREFERRED EMBODIMENT(S)

### I. Operating Environment

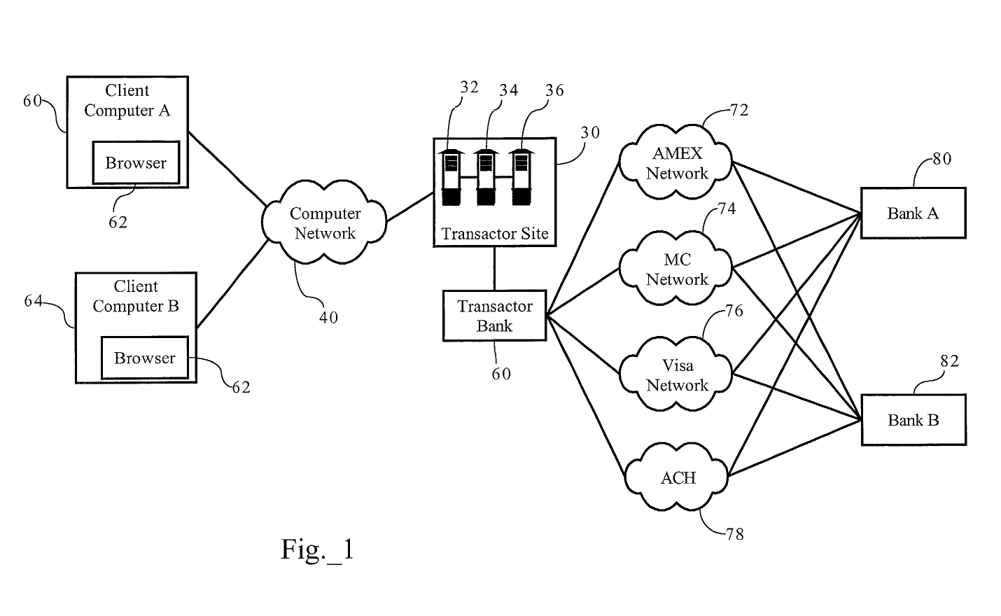

FIG. 1 illustrates an embodiment of the present invention as applied to computer network 40. Computer network 40 can be any suitable computer network, including an open, wide-area network, such as the Internet. In addition, computer network 40 can comprise an electronic network, an optical network, a wireless network, and/or a combination thereof. In addition, embodiments of the present invention operate in connection with a telecommunications network (e.g., a land-based telephone network, a wireless telephone network, and/or a combination thereof). As FIG. 1 shows, one embodiment of the present invention operates in a computer network environment comprising transactor site 30, at least one network access device, such as client computer 66, transactor bank 60, at least one transaction processing network (e.g., Automated Clearing House (ACH) Network 72), and at least one financial institution (e.g., Bank A 80).

A. Transactor Site 30

Transactor site 30 facilitates the transfer of funds between users. In one embodiment, transactor site 30 includes functionality directed to the storage and management of data, payment work flows, notification of users, risk management, presentation, and auditing. In one embodiment, users must register with transactor site 30 and obtain a user account to transfer and receive funds using transactor site 30. In one embodiment, transactor site 30 maintains a plurality of user accounts each including data relating to payment mechanisms and financial accounts specified by the user, such as credit card account numbers and expiration dates, checking account routing and transit numbers, checking account numbers, mailing address. In one form, such user accounts also include data relating to account status, transaction status, transaction history, etc. In one embodiment, the payment system functionality of transactor site 30 can be incorporated into an electronic wallet service or personal electronic commerce manager.

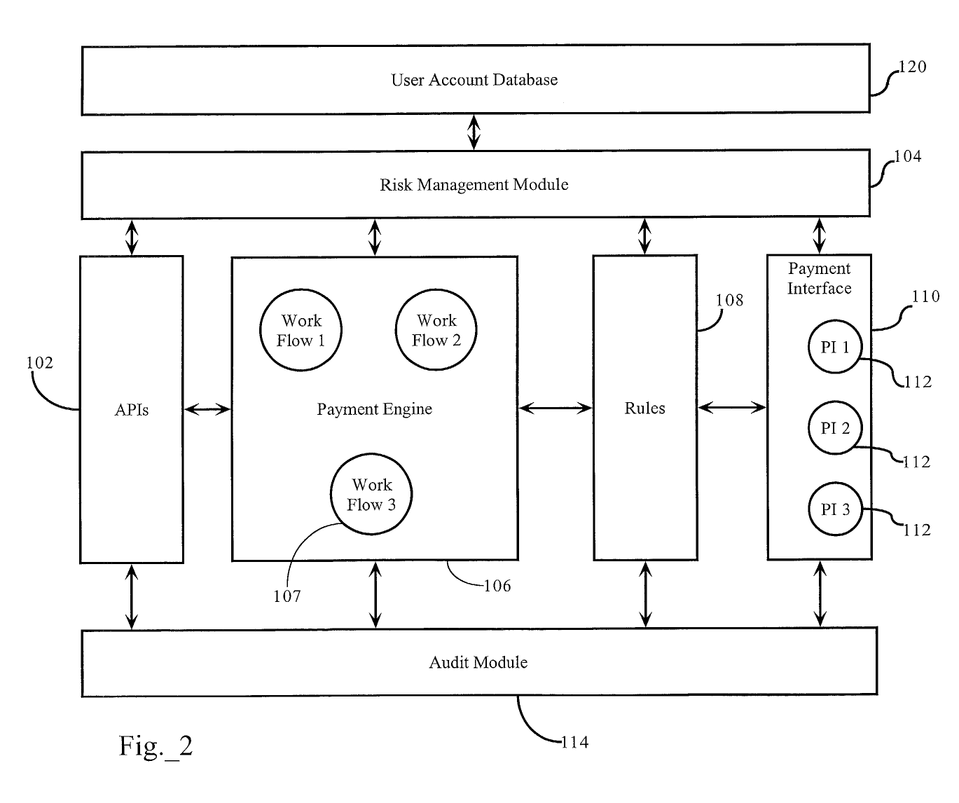

In one embodiment, transactor site 30 is a web site comprising web server 32, application server 34 and database server 36. Web server 32 receives requests submitted by users over computer network 40 and passes them to application server 34. In one embodiment, web server 32 transmits data to users using the SSL (“Secure Sockets Layer”) encryption protocol, the S-HTTP (“Secure HTTP”) protocol, or any other similar protocol for transmitting confidential or private information over an open computer network. Application server 34 executes the functionality required for facilitating payments between users. In one embodiment, such functionality includes authenticating users, registering users, and processing transactions. Application server 34, according to one embodiment, accesses database server 36 and generates pages that web server 32 transmits over computer network 40 to client computer 66. Database server 36 stores content and other data relating to the operation of the web site, such as user account data. In one embodiment, database server 36 includes user account database 120 (see FIG. 2 and section II.A.1, infra). In one embodiment, application server 34 includes application programming interface 102, payment engine 106, risk management engine 104, rules engine 108, payment interface 110, and audit module 114 (see FIG. 2).

Transactor site 30, in one embodiment, further includes functionality allowing users to access the payment functionality described herein using a telephone. In one embodiment, transactor site 30 includes interactive voice response systems allowing users to access accounts and specify payments to users.

Transactor site 30, in one embodiment, maintains at least one settlement account at transactor bank 60. In one embodiment, the debit side of each payment transaction conducted through transactor site 30 moves funds into a settlement account, while the credit side of the transaction moves funds out of a settlement account. Although not shown, transactor site 30, in other embodiments, maintains a plurality of settlement accounts at different transactor banks.

In one embodiment, transactor site 30 is an Application Service Provider (ASP) to at least one enterprise, such as a bank or other financial institution. In one form, transactor site allows its client enterprises to brand the services and functionality executed by transactor site 30 as their own. In one embodiment, the functionality of transactor site 30 is callable by a plurality of different sites via application programming interfaces. In another embodiment, the functionality performed by transactor site 30 is integrated into the on-line operations of a financial institution, such as a bank, or an electronic wallet services provider.

As discussed above, in one embodiment, transactor site 30 supports electronic wallet and/or personal electronic commerce managers including the payment functionality described herein. In one form, users access the payment and other functionality described herein with a network access device including a wallet client that augments the functionality of the network access device to facilitate transactions and payments conducted over computer network 40. In one embodiment, where transactor site 30 is an ASP to a plurality of financial institutions, the wallet client and the wallet services provided in association therewith are branded with the financial institution associated with corresponding users. In one form, the wallet client transmits a user identification associated with a user to transactor site 30, which resolves the financial institution associated with the user identification and brands the services accordingly. In one embodiment, the electronic wallet services provided to the user perform such tasks as automated operation of page-based interfaces, such as filling out purchase order forms and the like. In one embodiment, the wallet client facilitates log-in and subsequent interaction with transactor site 30.

In one embodiment, transactor site 30 charges a fee for payments made using the system. In one form, transactor site 30 charges the payer a flat fee for each payment. In one embodiment, transactor site 30 charges the payer based on a percentage of the payment amount. In another form, transactor site 30 charges a flat fee, plus a percentage of the payment amount. Other transaction charge protocols are possible. For example, in solicited payments (see below), the payee who sent the invoice can be charged.

B. Transactor Bank 60

Transactor bank 60 receives transaction and transaction-related instructions from transactor site 30 and executes them as required. In one embodiment, transactor bank 60 maintains at least one settlement account on behalf of transactor site 30. In one form, transactor bank 60 is the acquiring processor for transactor site 30 involving credit and debit card transactions. In addition, transactor bank 60, in one embodiment, also executes ACH transactions on behalf of transactor site 30. In one embodiment, transactor bank 60 and transactor site 30 are separate legal entities. In another embodiment, the functionality of transactor site 30 can be incorporated into the operations of transactor bank 60. In addition, as discussed above, transactor site 30 may operate with a plurality of transactor banks.

C. Transaction Processing Networks

Payment transaction processing networks 72, 74, 76, and 78 correspond to a plurality of different non-cash payment mechanisms, such as credit card, debit card, and Automated Clearing House (ACH) transaction processing networks. According to one embodiment, the transaction processing networks can be a credit card or debit card transaction processing network, such as VISA®, MASTERCARD®, DISCOVER®, or AMERICAN EXPRESS®. In one embodiment, the transaction processing networks enable users, at client computers 66, to provide a non-cash method of payment to transactor site 30. Additionally, the transaction processing networks also enable transactor site 30 via transactor bank 60, in one embodiment, to direct payments to specified users. Further, although FIG. 1 shows transactor bank 60 to be directly connected to the transaction processing networks, communication of data between transactor bank 60 and the transaction processing networks can occur over a separate, dedicated network or communication line.

D. Financial Institutions

Banks 80 and 82 are financial institutions at which users maintain checking and other financial accounts, such as savings accounts, money market accounts, credit and/or debit card accounts, etc. Although, in the illustrative embodiments described herein, one bank corresponds to each user, each user can have a plurality of bank accounts at one to a plurality of financial institutions. For example, a user, User A, may have a checking account at one financial institution and a credit card account with a different financial institution.

As discussed in Section II.B.3., infra, banks 80 and 82, in one embodiment, have a preestablished relationship with transactor site 30, pursuant to which participating banks maintain a settlement account reserved for transactions involving transactor site 30.

E. Client Computer

Users access the payment system with a network access device, which receives and transmits data over a computer network. In one embodiment, a network access device is a browser executed on a personal computer, a browser executed on a network computer, a browser on a cell phone or personal digital assistant, or a voice response unit on a telephone. As described below, a network access device can also be a telephone (wireless or otherwise) operating in connection with interactive voice response functionality located at transactor site 30. In one embodiment, a wallet client augments the network access device to facilitate payments and other transactions conducted in association with transactor site 30. In one form, users launch the payment functionality described herein by activating controls in the user interface presented by the wallet client.

One embodiment of present invention is implemented using page-based interfaces transmitted to client computer 66 having a browser 62 and a connection to computer network 40. One embodiment of the present invention contemplates that users have access to at least one client computer 66 or other terminal for accessing data over computer network 40 and possess at least one e-mail account. Client computer 66 can be any computer, special-purpose computing device, or any other suitable device for performing the required functionality. In one embodiment, client computer 66 includes at least one processor, a data storage system (including volatile and non-volatile media), a keyboard, a display, at least one input device and at least one output device. In one embodiment, the user's computer is connected to the Internet via a modem dial-up connection or through a network line. Such communication, however, could also be wireless. In one embodiment, client computer 66 includes electronic wallet software (e.g., a wallet client) that facilitates transactions over computer networks. In one form, the electronic wallet software comprises client-side software that operates in conjunction with a remote wallet server at transactor site 30 connected to computer network 40. In addition, although embodiments of the system are described as working in conjunction with a browser, any suitable device or application for receiving, displaying and transmitting data over a computer network can be used in the present invention. In one embodiment, the browser 62 implemented on client computer 66 supports the SSL (“Secure Sockets Layer”) protocol, the S-HTTP (“Secure HTTP”) protocol, or any other similar protocol for transmitting confidential or private information over an open computer network.

Users are individuals or other legal entities having the capacity to possess financial accounts, such as corporations, partnerships, non-profit organizations, trusts, and the like. In one embodiment, each user has at least one credit or debit card account and at least one checking or other financial account.

### II. Operation

A. User Registration and Accounts

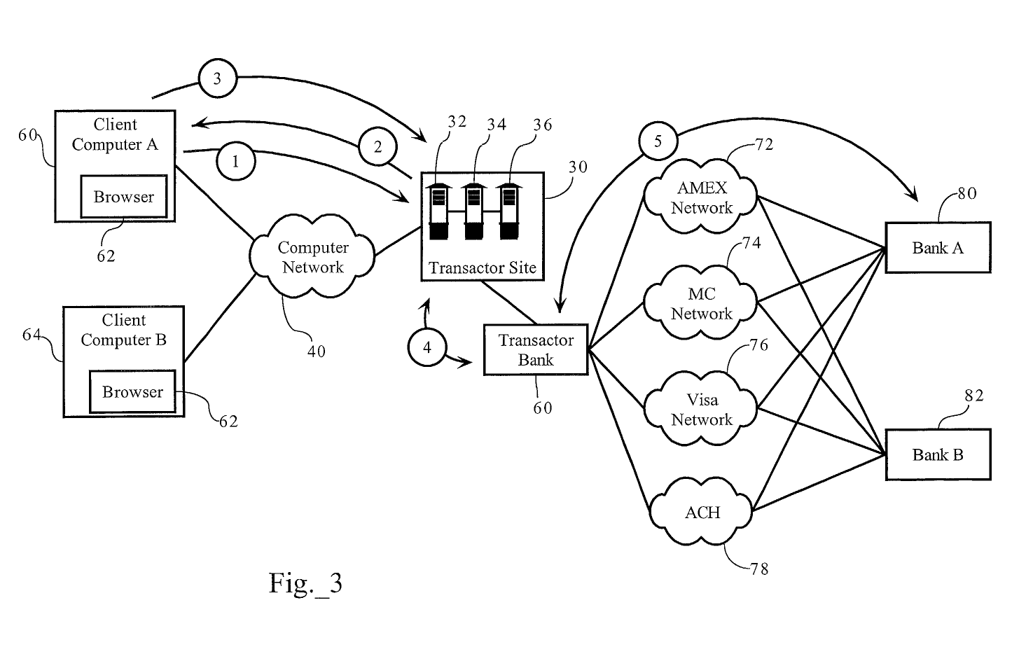

FIG. 3 illustrates the flow of data involved in a method for registering or signing up users of the payment system. In one embodiment, registration of users comprises a two-phase process. In the first phase, the user provides certain identifying information. In the second phase, the user provides information relating to at least one of his or her financial accounts. For illustrative purposes, assume that a user, user A, at client computer A 66 has at least one financial account, such as a credit card or checking account at Bank A 80.

In the first phase, a user, at client computer A for example, accesses transactor site 30 to initiate the sign-up process. Transactor site 30 transmits a form to client computer 66 prompting the user to enter certain user account data. In one embodiment, the form includes the following fields: name, address, e-mail address, a password, and a secret for password recovery. According to this embodiment, the user completes the form and transmits it to transactor site 30 (FIG. 3, #1). Transactor site 30 receives the form data submitted by the user and, in one embodiment, transmits a confirmation e-mail message to the e-mail address specified by the user (FIG. 3, #2).

In one embodiment, the confirmation e-mail message includes a uniform resource locator (URL) which, when used, allows the user to complete the registration process. In one embodiment, the URL is transmitted as a hypertext link, which, when clicked, opens up a browser window and transmits a request to complete the registration process. Upon receipt of the request, transactor site 30 transmits another form asking the user for additional data. In one embodiment, the form includes any or a combination of the following fields relating to the user's financial accounts: credit card account number, expiration date, billing zip code, card verification value 2, checking account routing and transit number, and checking account number. In another embodiment, the confirmation e-mail includes the form. In either embodiment, the user completes the form and transmits it to transactor site 30 (FIG. 3, #3).

Transactor site 30 verifies at least a portion of the data provided by the user and activates the account if the data is properly verified. In one embodiment, transactor site 30 validates at least one non-cash method of payment specified by the user. For example, assuming the user provides a credit card account number, transactor site 30 transmits an authorization request to transactor bank 60. In one embodiment, the authorization request seeks authorization of $0.01 and includes a request to verify the user's address using the Address Verification System (AVS) (FIG. 3, #4). Transactor bank 60 transmits the authorization request via the appropriate transaction processing network to Bank A (FIG. 3, #5). Bank A processes the authorization request and transmits a response to Transactor bank 60, which passes the response to transactor site 30. If the account data provided by the user is properly verified, transactor site 30 activates the user's account.

1. User Accounts and Account Status

In one embodiment, users have corresponding user accounts stored in a user account database 120 on database server 36. In one form, each user account includes the data submitted by the user in the registration process, described above. As discussed below, each user account may also include user preferences and system settings. For example and in one embodiment, users may flag their accounts with an “auto-receive” parameter in order to automatically receive payments without having to log in to transactor site 30 (see Section II.B.1.c., infra).

In one embodiment, users have the ability to monitor the status of their accounts and the transactions involving them. In one embodiment, when a user logs into transactor site 30, he or she is presented with an account status page including a list of pending and completed transactions involving the user. In one form, the list of transactions includes fields for the following information: 1) whether the user initiated or received the transaction; 2) whether the transaction is a payment or a bill; 3) the date and time of the initiation of the transaction; 4) the name of the recipient or originator (i.e., the other party in the transaction); 5) the amount of the transaction; and, 6) the current status (e.g., pending, complete, paid, notification sent to recipient, etc.).

In one embodiment, transactor site 30 allows users to conduct certain actions with respect to currently active or pending transactions. For example, if a transaction is pending intervention by the user (e.g., ‘picking up’ a payment to the user or paying a bill), the account status page, in one embodiment, allows the user to select the transaction and conduct the appropriate action. In addition, if the transaction is in a “pending” state, the account status interface, in one embodiment, allows the originator of the transaction to conduct actions such as canceling the transaction, or changing the e-mail address of the counter-party. In one embodiment, the account status interface allows both the originator and recipient of the transaction to initiate a customer service inquiry on the transaction. In one form, the account status page allows the user to display transaction information in a variety of ways. In one form, the account status interface allows the user to sort transaction information by 1) incoming vs. outgoing transactions; 2) payments vs. bills; 3) pending vs. completed transactions; 4) date; 5) counter-party e-mail address; and, 6) transaction amount. In one embodiment, the account status interface, in a default mode, displays a list of transactions in date descending order.

In one embodiment, transactor site 30 provides users an account update interface that displays the user's account configuration parameters and allows the user to update them. In one embodiment, the account update interface allows for 1) management of user's email addresses (multiple); 2) management of credit and debit instruments; 3) management of display parameters for the accounts page; 4) management of regular payees and bill-to addresses lists; and 5) selection of the “auto-receive” option and credit instrument (see, e.g., Section II.B.1.c, infra).

2. E-mail Addresses

Transactor site 30, in one embodiment, allows an individual user to have a plurality of e-mail addresses associated with an account. In one embodiment, if a user logs in to transactor site 30 responding to a notification sent to an e-mail address (e.g., by clicking on a URL in the notification e-mail) that is not associated with the user's account, transactor site 30 prompts the user to indicate whether he or she wishes to add the e-mail address to the account. If the user responds affirmatively, the email address is added with a qualified flag and all transactions outstanding for that email address will be merged into the corresponding user account. For example, User Bob (registered e-mail address: bob@hotmail.com) receives a payment from User Alice at his alternate email address, bob@yahoo.com. Bob has never registered or used the latter email address with transactor site 30. Bob follows the URL within the email and logs in as Bob. Transactor site 30 looks up the e-mail address sent as a parameter in the URL, sees that it is not Bob's registered email address and asks Bob if he wishes to add it to his account. If the email address is already allocated to another account, transactor site 30 displays an error message stating that the user may have multiple accounts set up. If Bob responds affirmatively, all transactions for that email address are now attached to Bob's account and can be viewed in the account status interface.

3. Phone Numbers

In one embodiment, transactor site 30 includes functionality allowing users to transfer and receive funds by specifying a telephone number. The telephone numbers can be associated with a regular telephone connected to a conventional land line or a wireless device, such as a cellular phone operably connected to a cell system. One embodiment of the present invention takes advantage of messaging functionality associated with cellular phones, such as Short Message Service (SMS) functionality available on wireless phones that use Global System for Mobile (GSM) communication, or a WAP push message on WAP-enabled phones. For example, at or after enrollment, a user registers his or her wireless phone number with transactor site 30. Transactor site 30, in one embodiment, transmits a SMS message with a one-time key to the user's wireless phone. In one form, the SMS message includes a telephone number corresponding to an interactive voice response system that, when dialed, prompts the user to enter the one-time key. Transactor site 30 then binds the user's phone number to his or her account.

In another embodiment, a pre-paid debit account enrollment package can offer a user a way to register his or her phone number in order to receive funds in the pre-paid debit account. For example and in one embodiment, a user purchases or otherwise receives a pre-paid debit account enrollment package. The package includes a telephone number to call and a one-time enrollment identification. The user calls the number, enters the onetime enrollment identification and the user's phone number. Transactor site 30 prompts the user for a PIN and then binds the user's phone number to the pre-paid debit account. In either embodiment described above, the phone number may now be used to identify the corresponding user as a recipient of funds. In addition, as discussed below, enrollment of new users can be incorporated into payment operations.

B. Payment Flows

Payment engine 106, in one embodiment, includes a plurality of work flow modules 107 allowing for a variety of payment protocols and credit and debit mechanisms. In one embodiment, payment engine 106 includes work flow modules allowing users to make unsolicited or solicited payments to other users. Additionally, payment engine 106 further includes work flows allowing for a variety of payment mechanisms. The following descriptions assume that no errors occur in the processing of payments, such as when a user provides an invalid payment mechanism or has insufficient funds in an account.

1. Unsolicited Payments

Payment engine 106, in one form, includes a plurality of work flows supporting a variety of unsolicited payment protocols, including, but not limited to the following:

a. ACH Credit

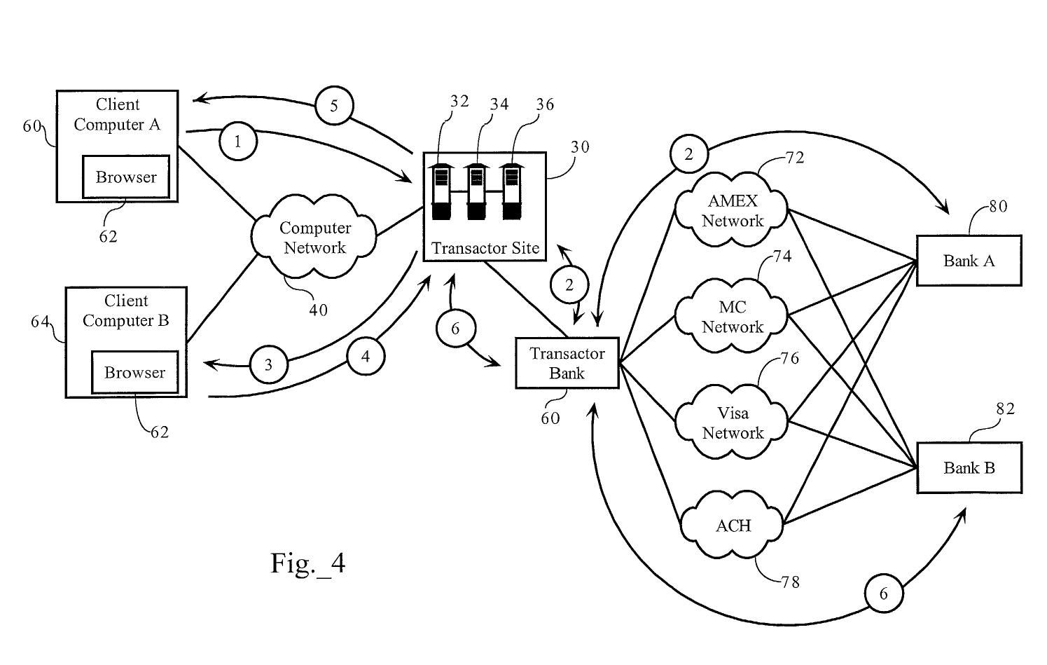

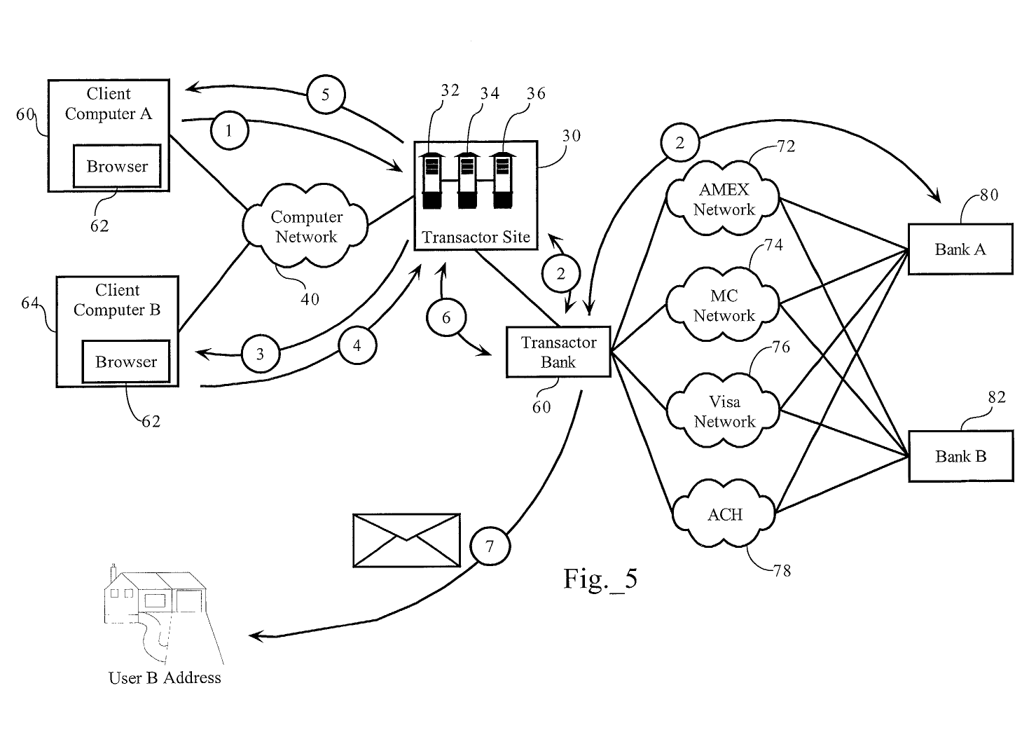

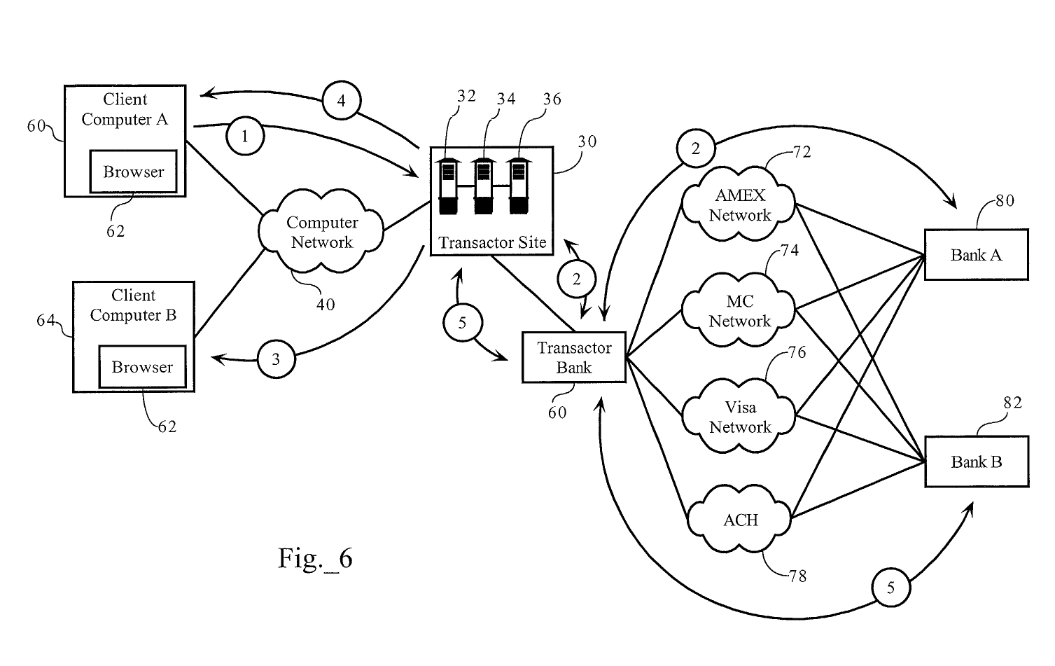

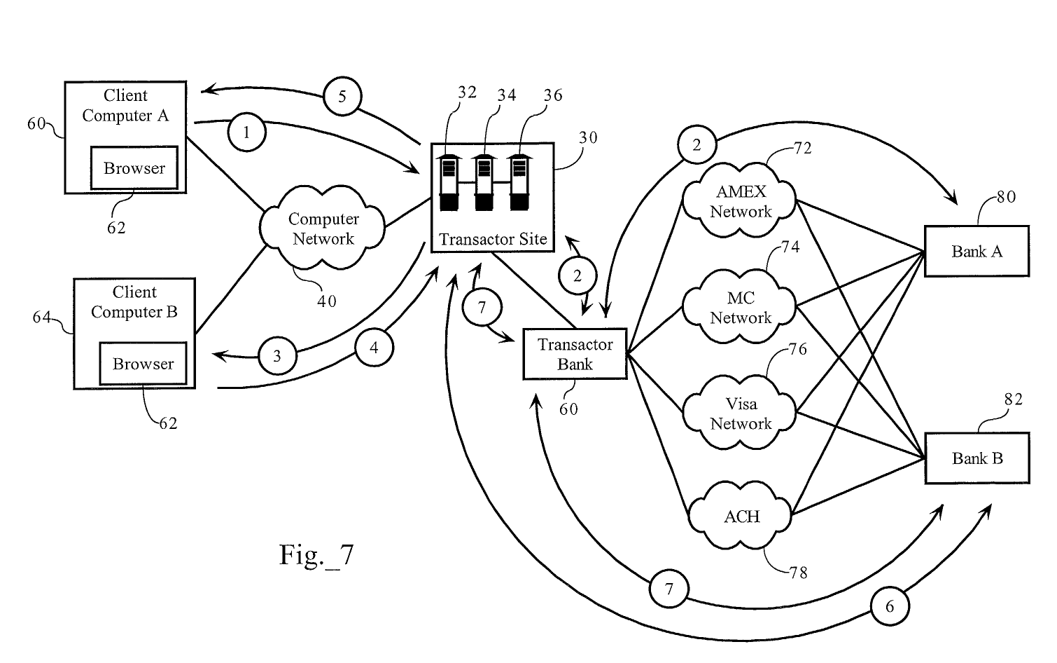

FIG. 4 shows the flow of data involved in one payment work flow, wherein the payer, User A, provides funds using a credit or debit card account with Bank A 80 and payee, User B, receives funds in his checking account at Bank B 82 through an Automated Clearing House (ACH) credit.

According to one embodiment, User A logs onto transactor site 30 and specifies a payment of $100.00 to User B (FIG. 4, #1) using a VISA credit card account with Bank A. In one embodiment, User A provides User B's e-mail address (e.g., UserB@domainB.com). Transactor site 30, via transactor Bank 60 and the VISA transaction processing network 76 transmits an authorization request to Bank A which transmits an authorization response in return (FIG. 4, #2). If the funds are authorized, transactor site 30 transmits a notification to User B via electronic mail (FIG. 4, #3). In one embodiment, transactor site 30 submits the $100.00 charge for settlement to the VISA transaction processing network 76 in a batch settlement process.

User B, at client computer B, receives the e-mail notification. In one embodiment, the e-mail includes a URL that takes the user to a login form for transactor site 30.

According to this payment flow, User B logs in to transactor site 30 and specifies in what form he wishes to receive the funds (FIG. 4, #4). In one embodiment, if User B is not a registered user, transactor site 30 registers the user according to the process described above (see Section II.A., supra). In one embodiment, transactor site 30 transmits an e-mail notifying User A that User B has initiated receipt of the payment (FIG. 4, #5). If User B elects to receive the funds from User A in his checking account, transactor site 30, via transactor bank 60, transmits a payment to User B's account at Bank B on the ACH network 78 (FIG. 4, #6).

b. Check Credit

As discussed above, payment engine 106, in one embodiment, includes a work flow module 107 allowing User A to initiate a payment to User B and allowing User B to receive a check for the amount specified by User A. At first, the payment flow is substantially the same as the ACH credit payment flow described above in section II.B.1 .a., supra. However, when User B accesses transactor site 30, he specifies that he wishes to receive a physical check as the payment mechanism (FIG. 5, #4). Transactor site 30 transmits check printing instructions to transactor bank 60 (FIG. 5, #6), which prints and mails the check to the address specified by User B (FIG. 5, #7). User B deposits the check with Bank B as any other conventional check.

c. Auto-Receive

In one embodiment, payment engine 106 includes a workflow 107 providing for automatic payments to User B, rather than requiring User B to log in to transactor site 30 to specify a payment mechanism. According to this payment flow, User B is a registered user of transactor site 30 and has flagged his account with an “auto-receive” parameter and specified payment via an ACH credit through an account maintenance screen.

FIG. 6 illustrates the flow of data involved in an “auto-receive” transaction wherein User A provides a credit card as the debit mechanism. User A logs onto transactor site 30 and specifies a payment of $100.00 to User B (FIG. 6, #1) using a VISA credit card account with Bank A. Transactor site 30, via transactor Bank 60 and the VISA transaction processing network 76, transmits an authorization request to Bank A which transmits an authorization response in return (FIG. 6, #2). If the funds are authorized, transactor site 30 transmits a notification to User B via electronic mail (FIG. 6, #3). In one embodiment, transactor site 30 also transmits an e-mail notification to User A that the transaction has been initiated (FIG. 6, #4). In one embodiment, transactor site 30 submits the $100.00 charge for settlement to the VISA transaction processing network 76 in a batch settlement process. Transactor site 30, via transactor bank 60, transmits a payment to User B's account at Bank B on the ACH network 78 (FIG. 6, #5).

d. Account Issuance Credit and Viral Marketing of Payment System including Electronic Wallets

In one embodiment, payment engine 106 includes a workflow 107 allowing the recipient to receive funds on a new debit or credit account. In one form of this embodiment, the payment system allows the recipient to receives the funds on a new debit or credit card account in connection with electronic wallet services. In one embodiment, the account data is stored in a new user account associated with the intended recipient. In one embodiment, the intended recipient also receives a wallet client that facilitates interaction with transactor site 30 and, therefore, payments and transactions over computer network 40. In one embodiment, the recipient also has the option to receive a plastic credit or debit card corresponding to the newly issued credit/debit account.

According to one embodiment, User A logs onto transactor site 30 and specifies a payment of $100.00 to User B (FIG. 7, #1) using a VISA credit card account with Bank A. In one embodiment, User A provides User B's e-mail address (e.g., UserB@domainB.com). Transactor site 30, via transactor Bank 60 and the VISA transaction processing network 76, transmits an authorization request to Bank A which transmits an authorization response in return (FIG. 7, #2). If the funds are authorized, transactor site 30 transmits a notification to User B via electronic mail (FIG. 7, #3). In one embodiment, transactor site 30 submits the $100.00 charge for settlement to the appropriate transaction processing network 76 in a batch settlement process.

User B, at client computer B, receives the e-mail notification. In one embodiment, the e-mail includes a URL that takes the user to a login form for transactor site 30. User B logs in to transactor site 30 and specifies in what form he wishes to receive the funds (FIG. 7, #4). In one embodiment, if User B is not a registered user, transactor site 30 registers the user according to the process described above (see Section II.A., supra). In one embodiment, transactor site 30 transmits an e-mail notifying User A that User B has initiated receipt of the payment (FIG. 7, #5). According to this embodiment, transactor site 30 offers User B the option to receive the funds on a new credit or debit card account. In one form, transactor site 30 offers User B the option to receive electronic wallet services associated with the new credit or debit card account. If User B elects to receive the funds from User A in a new credit or debit card account, transactor site 30 transmits an application form to User B. In one embodiment, the application form allows the user to specify whether he or she desires to receive an actual plastic card corresponding to the account to enable offline and other transactions. Upon receipt of the application form, transactor site 30 transmits a credit or debit card request to Bank B (FIG. 7, #6). Bank B process the request and issues a new credit or debit card account including a new account number and Personal Identification Number (PIN). In one embodiment, Bank B transmits the new credit or debit card account data to transactor site 30 (FIG. 7, #6). Once the account is established, transactor bank 60 wires the funds specified by User A to the User B's account with Bank B (FIG. 7, #7).

1) Prevention of User Churn

In one embodiment, certain parameters influence the branding of services provided by transactor site 30 and control whether and/or in what manner transactor site 30 offers a particular user the option to receive funds on a new credit card and/or financial services, including access to payment systems, electronic wallets and the like. For example and in one embodiment, transactor site 30 is an application service provider to a plurality of financial institutions such as Bank A and Bank B. Accordingly, in one embodiment, transactor site 30 employs protocols to help ensure that customers of Bank A are not marketed a new credit card account or other branded services with Bank B or any other client financial institution associated with transactor site 30. For this purpose, in one embodiment, transactor site 30 maintains a network association database of users associated with its client financial institutions. In one embodiment, this database of users is updated by either the client financial institutions or transactor site 30 on a periodic basis (e.g., in a nightly batch process). In one embodiment, if a user (payer or payee) is not found in the network association database, he or she is deemed not to be associated with a client financial institution and is deemed as “out-of-network”. In another embodiment, each user account in user account database 120 includes a field indicating a client financial institution associated with the user.

According to one embodiment, User A logs onto transactor site 30, acting as an ASP providing Bank A-branded payment services to User A, and specifies a payment of $100.00 to User B (FIG. 7, #1) using a VISA credit card account with Bank A. In one embodiment, User A provides User B's e-mail address (e.g., User_B@domainB.com). Transactor site 30, via transactor Bank 60 and the VISA transaction processing network 76 transmits an authorization request to Bank A which transmits an authorization response in return (FIG. 7, #2). If the funds are authorized, transactor site 30 transmits a notification to User B via electronic mail (FIG. 7, #3). In one embodiment, transactor site 30 submits the $100.00 charge for settlement to the appropriate transaction processing network 76 in a batch settlement process.

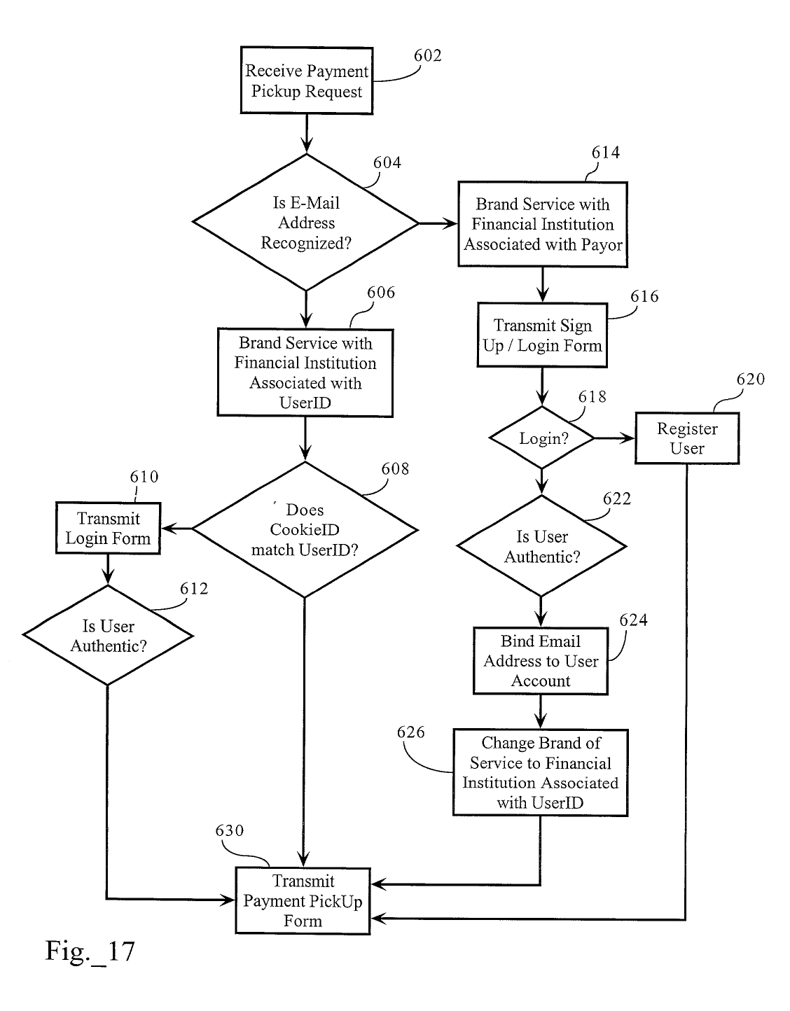

User B, at client computer B, receives the e-mail notification and logs in to transactor site 30 (FIG. 7, #4). In one embodiment, the e-mail includes a URL—including payment parameters such as the payer's identification, the payee's e-mail address, a payment identification, etc.—that when activated (e.g., clicked on by the user) causes the user's browser to compose and transmit a payment pickup request to transactor site 30 (see FIG. 17, step 602). In one embodiment, transactor site 30 transmits an e-mail notifying User A that User B has initiated receipt of the payment (FIG. 7, #5).

Upon receipt of the payment pickup request, transactor site 30 scans user account database 120 (or, in other embodiments, a separate network association database) for an email address that matches the one included in the request to identify whether the user has registered with transactor site 30 (FIG. 17, step 604). If User B is a registered user, transactor site 30 brands the services (e.g., the pages transmitted to the user) with the logos and trademarks of the financial institution associated with User B (step 606). For security purposes, transactor site 30 also checks whether the user identification in the cookie associated with the user's browser matches the user identification stored in user account database 120 (step 608). If so, transactor site 30 transmits a payment pickup page to the user including the branding associated with User B's financial institution (step 630). If the user identification in the cookie does not match, transactor site 30 requires the user to log in and authenticate himself (e.g., by supplying a password associated with the account) (see steps 610 and 612).

If transactor site 30 does not recognize User B's e-mail address, transactor site 30 brands the services with the logos and/or trademarks of the financial institution associated with User A, the payer/initiator of the payment transaction (step 614) and transmits a form instructing User B to sign up for an account in order to receive payment or to log in to an existing account (step 616). In one embodiment, the form includes hypertext links to the respective log-in forms of the client financial institutions of transactor site 30. If User B logs in and authenticates himself as the user of an existing account (see steps 618 and 622), transactor site 30 binds the new e-mail address to User B's existing account (step 624). Transactor site 30 then transmits a payment pickup page to User B branded with the logos and/or trademarks of the financial institution associated with User B (see steps 626 and 630). If the user elects to register as a new user, transactor site 30 registers the user and allows the user to pickup the payment. In each situation described above, transactor site 30 brands all further interactions with the logos and trademarks of the appropriate financial institution.

As discussed above, User B's network association also affects the manner in which financial services are marketed. As described above, when User B logs in (FIG. 7, #4), transactor site 30 presents a variety of payment options (e.g., check, ACH credit, or payment on a new credit or debit account). In one embodiment, transactor site 30, before presenting such payment options to User B, resolves User B's network association (i.e., whether User B is a customer of a bank in the transactor site's network of client financial institutions) to determine whether a new credit or debit card account will be marketed to User B. In one embodiment, all client banks of transactor site 30 are part of the network of banks. If User B is “in-network” (e.g., has a credit card account with an “in-network” bank or financial institution, such as Bank B or another client bank of transactor site 30), transactor site 30, in one embodiment, does not offer User B a new credit or debit card account. However, if User B is “out-of-network,” the payment options presented to User B includes the ability to receive the funds specified by User A in a new credit or debit card account with Bank A, an “in-network” financial institution. In one embodiment, transactor site 30 offers User B electronic wallet services in connection with the pre-paid credit or debit card account. User B's network association can be resolved by accessing user account database 120 or a network association database (see above) that includes network association data beyond User B's affiliation with a particular payment system. For example, although User B may be a registered user and associated with Bank B, User B may also have a credit card account with another client financial institution that he has not registered with transactor site 30. In such an instance, transactor site 30 must access a network association database to determine whether a new credit or debit card account should be marketed to User B.

Lastly, assuming transactor site's 30 protocols allow it, if User B specifies that he wishes to receive the funds from User A in a new credit or debit card account, transactor site 30 transmits an application form to User B. Upon receipt of the application form, transactor site 30 transmits a credit or debit card account request to Bank A (FIG. 7, #6). Bank A processes the request and issues a new credit or debit card account including a new account number and Personal Identification Number (PIN). In one embodiment, Bank A transmits the new credit or debit card account data to transactor site 30 (FIG. 7, #6). Once the account is established, transactor site 30 instructs its bank, transactor bank 60, to wire the funds specified by User A to User B's new account with Bank A (FIG. 7, #7). In one embodiment, transactor site 30 packages the new financial account as part of an electronic wallet offered to the user. In one embodiment, the electronic wallet includes an wallet client, downloaded to and installed on the user's network access device, that facilitates operation of the wallet based services on transactor site 30.

Accordingly, the embodiments described above include a viral component where use of the system automatically advertises the branded electronic wallet, payment services, and/or financial account services offered by transactor site 30 and/or the client financial institutions. Moreover, the embodiment described above allows transactor site 30, acting as an application service provider, to deploy viral marketing strategies and techniques in its services while eliminating the potential for churn among users of the client financial institutions.

2. Solicited Payments

Payment engine 106, in one embodiment, also supports solicited payment work flows, wherein a user submits an invoice to another user and obtains payment via transactor site 30.

a. ACH Credit

As FIG. 8 shows, User B in one embodiment, accesses transactor site 30 and submits an invoice, including the identity of the recipient (e.g., User A) and the amount (FIG. 8, #1). In one embodiment, User B further provides the e-mail address of the intended recipient. Transactor site 30 transmits an e-mail to User A notifying her of the invoice from User B (FIG. 8, #2). In one embodiment, the notification e-mail includes a URL directing User A to transactor site 30. When User A accesses transactor site 30, she is presented with the invoice submitted by User B and is provided the option to pay it electronically. According to this example, User A authorizes payment of the invoice with a credit card account (FIG. 8, #3).

Transactor site 30, via transactor Bank 60 and the appropriate transaction processing network transmits an authorization request to Bank A which transmits an authorization response in return (FIG. 8, #4). If the funds are authorized, transactor site 30 transmits a notification to User B via electronic mail (FIG. 8, #5). In one embodiment, transactor site 30 submits the charge for the invoice amount for settlement to the VISA transaction processing network 76 in a batch settlement process.

User B, at client computer B, receives the e-mail notification. In one embodiment, the e-mail includes a URL that takes the user to a login form for transactor site 30. According to this payment flow, User B logs in to transactor site 30 and specifies in what form he wishes to receive the funds (FIG. 8, #6). In one embodiment, transactor site 30 transmits an e-mail notifying User A that User B has initiated receipt of the payment. If User B elects to receive the funds from User A electronically into his checking account, transactor site 30, via transactor bank 60, transmits a payment to User B's account at Bank B on the ACH network 78 (FIG. 8, #7).

In another embodiment, User B may be paid without having to log in to transactor site 30 if his account is flagged with an auto-receive parameter (see Section II.B.1.c., supra).

b. Check Credit

As with unsolicited payments, payment engine 106, in one embodiment, includes a work flow 107 allowing User B to receive a check for the invoice amount. At first, the payment flow is substantially the same as the ACH credit payment flow described above in section II.B.2.a., supra. However, when User B accesses transactor site 30, he specifies that he wishes to receive a physical check as the payment mechanism (FIG. 9, #6). Transactor site 30 transmits check printing instructions to transactor bank 60 (FIG. 9, #7), which prints and mails the check to the address specified by User B (FIG. 9, #8). User B deposits the check with Bank B as any other conventional check.

c. Card Issuance Credit

Payment engine 106 further supports a payment flow that allows User B to receive the solicited funds in a credit card or debit card account. As described above, transactor site 30, in one embodiment, resolves User B's network association before determining whether to market him a new credit card account.

Specifically, User B, in one embodiment, accesses transactor site 30 and submits an invoice, including the identity of the recipient (e.g., User A) and the amount (FIG. 10, #1). In one embodiment, User B further provides the e-mail address of the intended recipient. Transactor site 30 transmits an e-mail to User A notifying her of the invoice from User B (FIG. 10, #2). In one embodiment, the notification e-mail includes a URL directing User A to transactor site 30. When User A accesses transactor site 30, she is presented with the invoice submitted by User B and is provided the option to pay it electronically. According to this example, User A authorizes payment of the invoice with a credit card account (FIG. 10, #3).

Transactor site 30, via transactor Bank 60 and the appropriate transaction processing network transmits an authorization request to Bank A which transmits an authorization response in return (FIG. 10, #4). If the funds are authorized, transactor site 30 transmits a notification to User B via electronic mail (FIG. 10, #5). In one embodiment, transactor site 30 submits the charge for the invoice amount for settlement to the appropriate transaction processing network 76 in a batch settlement process.

User B, at client computer B, receives the e-mail notification. In one embodiment, the e-mail includes a URL that takes the user to a login form for transactor site 30. According to this payment flow, User B logs in to transactor site 30 and specifies in what form he wishes to receive the funds (FIG. 10, #6). In one embodiment, transactor site 30 transmits an e-mail notifying User A that User B has initiated receipt of the payment. If User B specifies that he wishes to receive the funds from User A in a new credit or debit card account, transactor site 30 transmits an application form to User B. Upon receipt of the application form, transactor site 30 transmits a new credit or debit card account request to Bank B (FIG. 10, #7). Bank B process the request and issues a new credit or debit card account including a new account number and Personal Identification Number (PIN). In one embodiment, Bank B transmits the new credit or debit card account data to transactor site 30 (FIG. 7, #7). Once the account is established, transactor bank 60 wires the funds specified by User A to User B's newly established account with Bank B (FIG. 7, #8).

3. Sending Payments to Phone Numbers

Transactor site 30, in one embodiment, includes functionality allowing users to send and receive funds using a telephone number. The payment work flows are similar to those using e-mail addresses. One embodiment takes advantage of SMS or other messaging functionality associated with wireless telephone networks; however, other messaging protocols and functionality can also be used such as paging and voice mail. For example and in one embodiment, User A accesses transactor site 30 and specifies a payment of $100.00 to User B using User B's telephone number. Transactor site 30 looks up User B's phone number in user account database 120. If User B has an account, transactor site 30, in one embodiment, initiates a transfer of funds to User B's account. In one embodiment, transactor site 30 transfers funds to User B's account in a manner similar to the Auto-Receive payment work flows described above. However, in other payment work flows, User B responds to a payment notification and interacts with transactor site 30 to specify payment options and complete the transfer of funds.

In one embodiment, transactor site 30 notifies User B of the payment using the telephone number provided by User A. In one embodiment, transactor site 30 transmits payment notifications to the device associated with the specified telephone number. In one form, transactor site 30 transmits an SMS or other message to User B's cell phone. Transactor site 30 can employ other methods of notification, such as leaving a voice-mail message, on User B's cell or regular phone. In one embodiment, transactor site 30 allows users to specify the channel for transmitting notifications associated with operation of transactor site 30. In another embodiment, transactor site 30 includes interactive voice response technology that transmits a voice mail notification of the payment. In one embodiment, transactor site 30 includes functionality that stores the payment notification in a database and makes iterative attempts to transmit the payment notification until a payment notification is successfully transmitted (e.g., SMS message sent, voice mail message left, user answers phone and interacts with voice response system to complete payment, etc.).

In one embodiment, if User B is not a registered user, transactor site 30 transmits a payment notification via a SMS or other message to the device associated with the telephone number. In one embodiment, the message informs User B of the payment and provides account enrollment information (see above). User B may then register over the telephone or on-line and receive the funds transferred by User A.

4. Batch Settlement Model

In one embodiment, transactor site 30 maintains a direct relationship with banks 80 and 82, as well as other participating financial institutions, to facilitate transactions between users. In one embodiment, participating financial institutions, such as banks 80 and 82, maintain at least one settlement account 85 reserved for transactions involving transactor site 30 (see FIG. 11, Ref. No. 85).

FIG. 11 illustrates the flow of data involved in one such embodiment. In one form, User A logs onto transactor site 30 and specifies a payment of $100.00 to User B (FIG. 11, #1) using funds in User A's account 87 with Bank A 80. In one embodiment, User A provides User B's e-mail address (e.g., UserB@domainB.com). Transactor site 30, in one embodiment, then notifies User B via e-mail that User A has initiated a payment (FIG. 11, #2). In one embodiment, transactor site 30 verifies that User A has sufficient funds in the specified account 87 before notifying User B. In another embodiment, the transaction can be initiated automatically if User B has elected to use the Auto-receive feature described above.

User B, at client computer B, receives the e-mail notification. In one embodiment, the e-mail includes a URL that takes the user to a login form for transactor site 30. According to this payment flow, User B logs in to transactor site 30 and specifies in what form he wishes to receive the funds (FIG. 11, #3). In one embodiment, if User B is not a registered user, transactor site 30 registers the user according to the process described above (see Section II.A., supra). In one embodiment, transactor site 30 transmits an e-mail notifying User A that User B has initiated receipt of the payment. If User B specifies that he wishes to receive the funds from User A in his checking or other financial account 88 with Bank B 82, transactor site 30 issues transaction-related instructions to both Bank A and Bank B (FIG. 11, #'s 4 and 5).

In one embodiment, transactor site 30 transmits instructions directing Bank A to transfer funds from User A's account 87 to Bank A's settlement account 85 (FIG. 11, #4). Similarly, transactor site 30 transmits instructions to Bank B directing Bank B to transfer funds from its settlement account 86 to User B's account 88 (FIG. 11, #5). Communication of such instructions between transactor site 30 and banks 80 and 82 can occur over a variety of communication paths, such as an open computer network 40 (using encryption and authentication protocols), or dedicated lines. In one embodiment, transactor site 30 stores in a database instruction and transaction data necessary to square the settlement accounts of the participating banks. In one embodiment, transactor site 30 on a periodic basis (e.g., daily, hourly, weekly, etc.) processes the instruction and transaction data to calculate the transfers necessary to square the settlement accounts of all participating banks (here, settlement accounts 85 and 86). In one embodiment, transactor site 30 transmits instructions resulting from such calculations to transactor bank 60 (FIG. 11, #6a). Transactor bank 60, in one embodiment, transmits these instructions over FedWire 75 or some other bank-to-bank transaction processing network to the participating banks (FIG. 11, #6b & 6c). For example, if the transaction between User A and User B were the only transaction conducted in a settlement period, transactor site 30 would issue transaction instructions via transactor bank 60 and FedWire 75 that would result in the transfer of $100.00 from Bank A's settlement account 85 to Bank B's settlement account 86 (FIG. 11, #6d).

C. Risk Management System and Explicit Trust Modeling

Accuracy of the user's account data is extremely important to the proper operation of the payment system and also helps to ensure against fraud. Accordingly, in one embodiment, the payment system functionality includes a risk management module 104. In one embodiment, risk management module 104 is based on a transaction risk model using certain criteria to determine transaction availability and transaction amount limits. In one embodiment, the criteria include: transaction history, current fraud trends, means of authentication and strength of the authentication means, as well as the certainty of relationships between critical user data elements.

Payment engine 106 includes functionality supporting a plurality of discrete payment operations. In one embodiment, payment engine 106 accesses risk management module 104 to obtain permission before executing a particular payment operation. In one embodiment, risk management module 104 executes rules-based tests associated with the particular payment operation and either authorizes the operation or vetoes it. In another embodiment, risk management module 104, operating separately from payment engine 106, evaluates and/or verifies user account data on a continuous or periodic basis.

In one embodiment, risk management module 104 is a configurable module comprising a set of RiskTests and RiskActions. In one form, any RiskTest or set of RiskTests may be associated with a discrete operation of payment engine 106. For example, and in one embodiment, AmountLimitRiskTest, xxExceptionListRiskTest, and RelationshipRiskTest are examples of RiskTests (see below). RiskActions can include operations that flag suspect payments, prevent further execution of payments failing a RiskTest, and/or schedule various verification checks, such as AVS, CVV2, and/or IFS checks. ScheduleAVS and SuspectPayment are examples of two RiskActions. Any RiskAction may be associated to any RiskTest's success or failure. So, for example, if a particular RiskTest succeeds, risk management module 104 may be configured to schedule an AVS check, but if it fails, risk management module may warn of possible fraud. In addition, any RiskTest or set of RiskTests may be associated to any payment engine operation.

1. RiskTests

RiskTests evaluate elements of payment and transaction data (e.g., payer identity, payee identity, payment amount, payment instrument, etc.) and, in one embodiment, operate to control execution of RiskActions. RiskTests, in one embodiment, include configurable parameters, including parameters relating to test criteria that ultimately yield a test state (e.g., success, failure, test strength values, etc.) and what actions (RiskActions) are to be performed in response to a particular test state. Below are examples of RiskTests according to one embodiment of the present invention.

a. AmountLimit RiskTest

The Amount Limit RiskTest tests whether a payment amount specified by a user exceeds a threshold level, “maxAmount.” In one embodiment, “maxAmount” is a configurable parameter indicating the maximum amount allowed for a particular payment. In embodiments where payment site acts as an ASP to a plurality of institutions, maxAmount can vary across institutions. In one embodiment, the AmountLimit Risk Test further includes the “successRiskAction” and “failRiskAction” parameters that specify the action(s) to be taken depending on the outcome of the AmountLimit RiskTest. For example, the “failRiskAction” parameter tells the AmountLimitRiskTest what to do when the test fails (the Payment amount is greater than maxAmount). In one embodiment, either a WarnOfPossibleFraud RiskAction OR a FailPayment RiskAction can be associated with the failRiskAction, which allows for warnings at some level, and a failure at another level. A successRiskAction, on the other hand, may simply be an action that allows a payment operation or other RiskTests to proceed.

b. AggAmountLimit RiskTest

Similar to maxAmount, “maxAggAmount” is a configurable parameter in the AggAmountLimit RiskTest that sets the maximum aggregate payment amounts that a given user can create in a predetermined period. In one embodiment, the predetermined period is also a configurable RiskTest parameter. For example, the payment system according to one embodiment may be set to no more than $1000 in aggregate payments in a 7 day period. Note that, in one embodiment, either a WarnOfPossibleFraud RiskAction OR a FailPayment RiskAction can be associated to the RiskTest, which allows for warnings at some level, and a failure at another level.

In one embodiment, the AggAmountLimit RiskTest is applied on a payment instrument level as opposed to a user identity level; that is, risk management module 104 applies the AggAmountLimit RiskTest using the payment instrument specified by the user rather than the user identity. This has especial application to embodiments where an individual user is allowed more than one account (and, therefore, more than one user identity) with transactor site 30.

c. ExceptionLists

In one embodiment, RiskTests include one to a plurality of ExceptionList tests that operate to exclude payments involving listed elements, such as payer or payee identifications, payment instruments, etc. In one embodiment, a failure of an ExceptionList RiskTest causes a failPayment operation causing payment engine 106 to cancel the transaction.

1) CCInstrumentExceptionList RiskTest

In one embodiment, CCInstrumentExceptionList looks up a given debit or credit instrument against a database of excluded debit and credit instruments.

2) ACHInstrumentExceptionList RiskTest

Similarly, ACHInstrumentExceptionList looks up a given financial account against a database of excluded financial accounts.

3) EmailExceptionList RiskTest

EmailExceptionList looks up a given email address against a database of excluded email addresses.

d. AVSCheck RiskTest

AVSCheck is a RiskTest that tests for a match between the address specified by the user and the address as obtained by an Address Verification System (AVS). In one embodiment, “successStates” is a configurable parameter specifying which AVS states are considered success conditions. In one embodiment, all other AVS states are considered failures. In one embodiment, the possible AVS states include:

Address and 9 digit zip code matches (EXACT_MATCH_AVS_STATUS)

Address matches, zip code does not (ADDRESS_MATCH_AVS_STATUS)

Address and 5 digit zip code matches (MATCH_AVS_STATUS)

Neither zip code nor address matches (NO_MATCH_AVS_STATUS)

Zip code matches, address does not (ZIP_AVS_STATUS)

9 digit zip code matches, address does not (EXACT_ZIP_AVS_STATUS)

AVS system down or not responding (TEMP_UNAVAIL_AVS_STATUS)

AVS information unavailable for address (PERM_UNAVAIL_AVS_STATUS)

AVS unavailable for specified card (CARD_NOT_SUPPORTED_AVS_STATUS)

e. CVCheck RiskTest

CVCheck is a RiskTest that verifies that a card validation value provided by the user matches the actual verification value on a particular user's credit card. For example, Visa includes a Card Verification Value (CVV2) on issued credit cards. Similarly, MasterCard's issued cards include the MasterCard Card Validation Code (CVC2). In one embodiment, “SuccessStates” is a parameter specifying which CVC2/CVV2 states are considered success conditions. All other states are considered failures. Possible states include:

CVC2/CVV2 matched (MATCH_CVV2_STATUS);

CVC2/CVV2 didn't match (NO_MATCH_CVV2_STATUS);

Unknown CVC2/CVV2 status. System can't process the cvv2 value, or cvv2 value not given (PERM_UNAVAIL_CVV2_STATUS); and

Unknown CVC2/CVV2 status. System was possibly temporarily unable to process (TEMP_UNAVAIL_CVV2_STATUS).

f. IFSCheck RiskTest

The IFSCheck RiskTest evaluates the results of an Internet Fraud Screen (IFS) test against a threshold parameter, “successLevel.” In one embodiment, the results of an IFS test are a numerical value between 0 and 100, where 0 is a very trusted transaction, and 100 is very untrusted transaction. In one embodiment, the “successLevel” parameter is a number between 0 and 100 determining the threshold level for success. If the IFS value is equal to or less than successLevel, this RiskTest is considered “successful”. In one embodiment, IFSCheck includes two levels of evaluation. For instance, “successStates” specifies which IFS states are considered “successful”. In one embodiment, if the state is not in this list, the RiskTest is failed, and the “successLevel” will be ignored. In one embodiment, possible states include:

Transaction was successful (SOK)

The credit card number did not pass CyberSource basic checks. This should NEVER be a success state. (DINVALIDCARD)

Of course, other states are possible; the foregoing merely illustrates exemplary test states.

g. Skeletons RiskTest

In one embodiment, risk management module 104 includes the Skeletons RiskTest that invokes a Suspect payment operation to flag a particular payment if a particular payer or payee identity has been involved in a threshold number of suspect or failed transactions in a predetermined period. For example, Skeletons operates to flag a payment as a suspect payment, if the payer has been involved in more than 4 suspect payments in the previous eighty (80) days. In one embodiment, both the threshold number of suspect or failed payments and the evaluation period are configurable parameters.

h. Velocity RiskTest

The Velocity RiskTest evaluates the frequency of payments associated with a user in a particular period. A variety of RiskActions, described below, can be associated with the success or failure of the Velocity RiskTest. For example and in one embodiment, Velocity invokes the SuspectPayment RiskAction, if a payer has requested more than two payments in the prior 7-day period. In another embodiment, Velocity invokes the FailPayment RiskAction, if the payer has requested more than 5 payments in a 24-hour period.

As with the AggAmountLimit RiskTest, in one embodiment, the Velocity RiskTest is applied on a payment instrument level as opposed to a user identity level. As above, risk management module 104 applies the Velocity RiskTest to the payment instrument specified by the user rather than the user identity.

### i. RelationshipStrength RiskTest

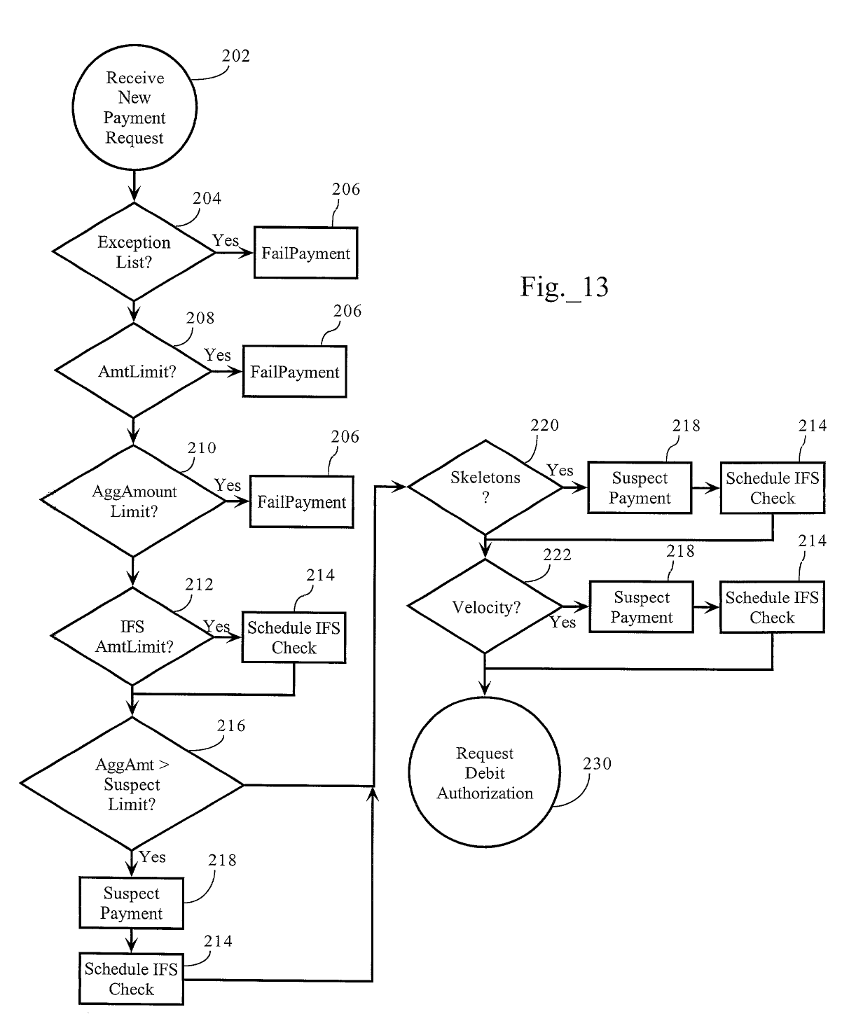

In one embodiment and as FIGS. 13-16 show, each RiskTest can be used in an individual manner to flag suspect transactions, kill fraudulent transactions, and to schedule or direct the performance of other Risk Actions. In one embodiment, however, the RelationshipStrength RiskTest aggregates the results of a plurality of RiskTests to obtain a holistic assessment of a particular payment. The “relationshiptypes” parameter specifies which types of relationships to consider. Types include “Identity”, “Address”, “CClnstrument”, “ACHlnstrument.” In one embodiment, RelationshipStrength is a weighted aggregate of the results of a plurality of RiskTests. For example, “verificationType2MultiplierMap” represents a mapping of type-strength multipliers to certain verification types. Verification types include: 1) AVS, 2) Credit Validation (CVV2/CVC2 checks), 3) IFS (CyberSource Internet Fraud Screen scores), 4) ST (Suspicious Transactions), and 5) FT (Failed Transactions). In one embodiment, strength values are a number between 0 and 100. In one embodiment, default strength-multiplier values are: AVS→0.1, CV→0.2, IFS→0.3, TXN→0.1, ST→−0.3, FT→−0.6. Note the negative value for “ST” or “FT”—they are always a bad relationship instance.

In addition, other parameters can also be used to control or influence the operation of RelationshipStrength. “VerificationType2CountMap” is a configurable parameter setting the last count instances of a given verification type that are considered in the strength score. In one embodiment, default values are AVS→3, CV→1, IFS→1. In one embodiment, a count value of 0 will ignore the type, and a count value of −1 will allow all instances to be considered (if they are younger than “efficacyPeriod” days). “EfficacyPeriod” (optional), if set, is a parameter causing risk management module 104 to consider only those relationship instances that fall within the EfficacyPeriod in the relationship Strength. In one embodiment, for example, EfficacyPeriod is 60 days. In one embodiment, more recent relationship instances factor more heavily in the relationship Strength score, while those more remote in time factor less heavily.

“SuccessStrength” is a threshold parameter indicating the lowest acceptable RelationshipStrength score that will result in a success condition. In one form, success Strength is number between 1 and 100. Higher numbers are stronger relationship strength. This RelationshipStrengthRiskTest is considered “successful” if the weighted aggregate relationship strength values for each considered relationship instance is equal to or greater than successStrength.

2. RiskActions

a. SuspectPayment RiskAction

SuspectPayment is a RiskAction that, in one embodiment, flags a particular payment as a suspicious transaction. In one embodiment, SuspectPayment operates to record data relating to the suspicious transaction in a report accessible to a manager of the payment system. In one form, SuspectPayment further operates to flag the user accounts of both the Payer(s) and the Payee(s) associated with the suspicious transaction. In one embodiment, SuspectPayment further operates to schedule an Internet Fraud Screen test involving the payment. See below. In one embodiment, however, risk management module 104 is configured to allow suspicious transactions to continue.

b. FailPayment RiskAction

FailPayment, like SuspectPayment, also flags a particular payment as a highly suspicious transaction and also operates to record data relating to the suspicious transaction in a report accessible to a manager or other administrator of the payment system. In one embodiment, FailPayment, when invoked, also instructs payment engine 106 to kill the payment operation implicated in the transaction. In one form, risk management module 104 is further configured to instruct payment engine 106 to execute other payment operations as required to cancel or otherwise negate the overall payment transaction.

c. ScheduleAVS RiskAction

The ScheduleAVS RiskAction, in one embodiment, operates to schedule an AVS check involving the payer's credit card account. As FIGS. 13-16 show, this RiskAction may be followed by an AVSCheck RiskTest to check the result of the AVS check at a subsequent point in the payment workflow.

d. ScheduleCV RiskAction

The ScheduleCV RiskAction, in one embodiment, operates to schedule an CV check involving the payer's credit card account. As FIGS. 13-16 show, this RiskAction may be followed by an ScheduleCV RiskTest to check the result of the CV check at a subsequent point in the payment workflow.

e. ScheduleIFSCheck and PerformIFS RiskAction

ScheduleIFSCheck operates to schedule an IFS check involving a particular transaction. PerformIFS, when invoked, operates to actually request an Internet Fraud Screen test. In one embodiment, the IFS test returns a value or number relating to the degree to which it is believed that a particular transaction involves fraud. In one embodiment, the Internet Fraud Screen test is performed by a third party, such as CyberSource Corporation of Mountain View, Calif.

In one embodiment, the Internet Fraud Screen test includes several configurable parameters affecting how a payment transaction is scored. For example and in one embodiment, “score_host_hedge” is a parameter that can be configured to increase or decrease the scored level of risk based on the e-mail and/or IP address associated with the payer. In one form, setting this parameter to “low” reduces the relative significance (as reflected in the IFS score) of payments initiated from an e-mail or IP address that is unknown in relation to the particular user. Conversely, setting this parameter to “high” increases the relative significance of an unknown e-mail or IP address. In one embodiment, setting this parameter to “off” prevents an unknown e-mail or IP address from affecting the IFS score.

Of course, numerous other parameters and settings can also be employed. For example, “score_time_hedge” increases or decreases the scored level of risk based on the time of day at which a payment order was received. One embodiment allows for the following “score_time_hedge” settings:

1) “Low”: Lower than average concern with time of day;

2) “Normal” (default): Average concern with time of day;

3) “High”: High concern with time of day; and

4) “Off”: Time of day does not affect the IFS score.

In addition, “score_velocity_hedge” Increases or decreases scored level of risk based on the number of payment orders placed with a particular credit card or other payment instrument within the preceding 15 (or some other number of) minutes. One embodiment allows for the following “score_velocity_hedge” settings:

1) “Low”: Lower than average concern. A transaction is declined on the sixth order within the predetermined period (e.g. 15 minutes) period;

2) “Normal” (default): Average concern. A transaction is declined on the fifth transaction within the predetermined period;

3) “High”: High concern. A transaction is declined on the fourth transaction within the predetermined period; and

4) “Off”: Purchase velocity does not affect the IFS score.

3. Exemplary Implementation of Risk Management Module

FIGS. 13, 14, 15 and 16 illustrate the operation of payment engine 106 and risk management module 104 according to one embodiment of the present invention, and also illustrate the association of RiskActions to the success and/or failure states of the RiskTests. As discussed above, one embodiment allows for a plurality of RiskTests to be associated with a payment operation. For example, when payment engine 106 receives a new payment request from a user (FIG. 13, step 202), it makes calls to risk management module 104 to either authorize or veto the payment operation. In one embodiment, payment engine 106 accesses associated RiskTest and RiskAction functionality provided by risk management module 104 to authorize or veto the current payment operation. As FIG. 13 illustrates, in one embodiment, risk management module 104 executes a plurality of RiskTests associated with the payment operation. In one embodiment, risk management module 104 applies the ExceptionList RiskTest 204 to determine whether the payer or the payer's specified credit or other payment instrument appears on an exclusion list. See Section II.C.1.c, supra. If a screened payment element appears on an exclusion list, risk management module 104 executes the FailPayment RiskAction 106 to veto the payment operation. See Section II.C.2.b., supra. Similarly, risk management module applies the AmountLimit 208 and AggregateAmountLimit 210 RiskTests, failures of which result in a FailPayment 206 RiskAction. See Sections II.C.1.a. & b., supra. In one embodiment, risk management module 104 schedules an IFS check (step 214), if the payment amount exceeds a predetermined threshold configured in IFSAmtLimit (step 212). For example, IFSAmtLimit can be configured to schedule an IFS check if the payment amount exceeds $200.00. In one embodiment, risk management module 104 executes the SuspectPayment (step 218), if the aggregate amount of payments made by the current user in a predetermined period exceeds a predetermined threshold (step 216). For example, while risk management module, in one embodiment, limits the aggregate payments for a user to $1000 in a 7-day period, risk management module 104 can also be configured to flag a payment where the aggregate payment amount exceeds $500 in the 7-day period. As FIG. 13 shows, other RiskTests can also be used. For example, risk management module 104 can apply the Skeletons RiskTest (step 220) (see Section II.C.1.g., supra) and the Velocity RiskTest (step 222) (see Section II.C.1.h., supra). If the payment operation has not been vetoed, risk management engine 104, in one embodiment, grants payment engine 106 permission to transmit a debit authorization request to the appropriate transaction processing network (step 230). In one embodiment, the debit authorization request includes an AVS and/or a Card Validation request.

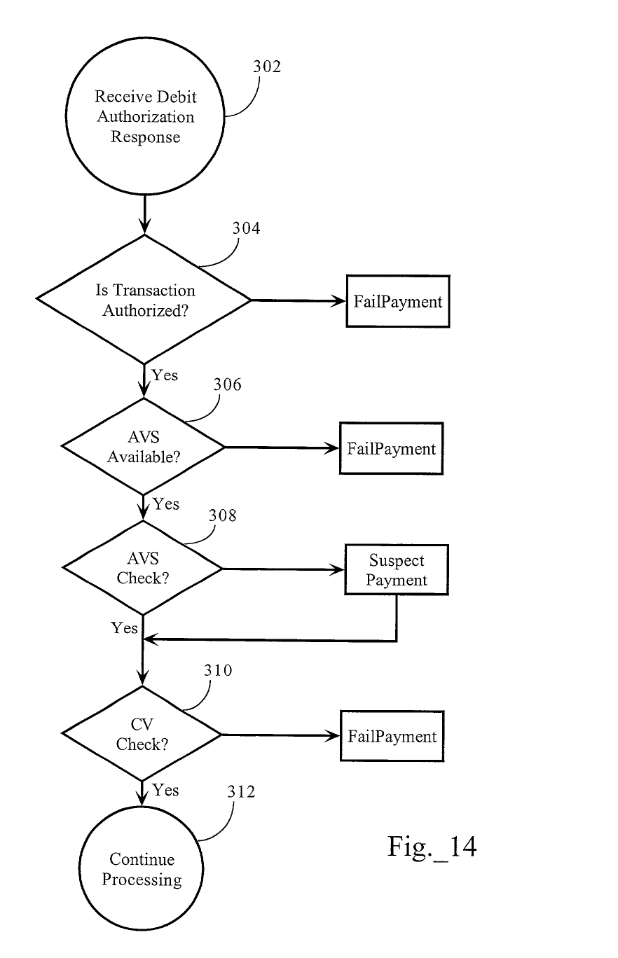

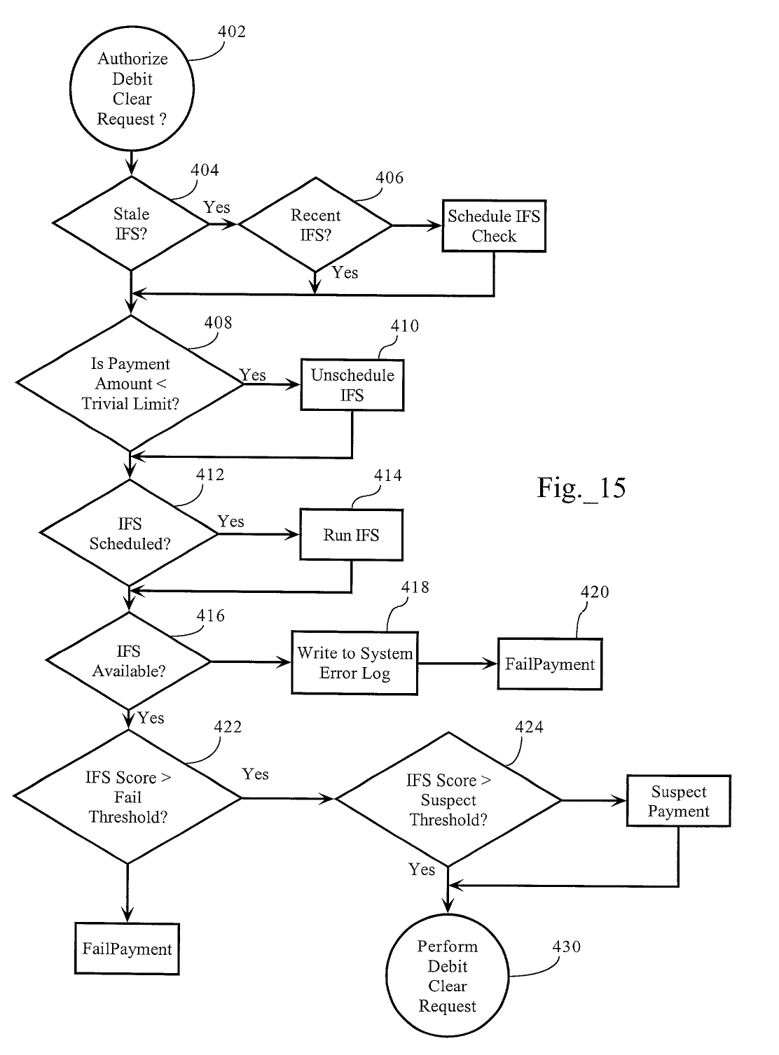

FIG. 14 illustrates a method allowing for evaluation of the response to the debit authorization request transmitted in step 230. In one embodiment, payment engine 106 receives the response (FIG. 14, step 302) and requests permission from risk management engine 104 to continue processing the payment. In one form, risk management engine 104 evaluates the authorization response to determine whether the transaction is authorized (step 304). In one embodiment, if no AVS data is available (step 306), risk management module fails the payment. In one embodiment, risk management engine 104 executes the AVSCheck Risk test on available AVS data (step 308). See Section II.C.1.d, supra. In one embodiment, if the results of the AVSCheck do not correspond to a success condition, the payment is flagged as a suspect payment. In one embodiment, risk management module 104 also executes the CVCheck RiskTest (step 310). In one embodiment, a failure of the CVCheck RiskTest results in a FailPayment operation. If the payment passes these RiskTests, it is passed to other payment operations for further processing (step 312) (see FIG. 15).

FIG. 15 illustrates a method involved when payment engine 106 seeks permission from risk management module 104 to transmit a debit clear request to the appropriate transaction processing network. In one embodiment, StaleIFS RiskTest ensures that an IFS test is performed at a minimum frequency with respect to a particular payer. In one embodiment, StaleIFS determines whether the payer has made less than two payments in the last 80 days and whether no IFS test was performed for such payments. If so, risk management engine 104 schedules an IFS check. In one embodiment, risk management module 104 un-schedules an IFS check (step 310), if the payment amount is less than a trivial amount threshold (e.g., $10.00). In one embodiment, risk management module 104 determines whether as IFS check is scheduled for the payment (step 412) and, if so, requests or performs an IFS check (step 414). If IFS results are not available (see step 416), risk management module 104 writes the failure to the system error log (step 418) and fails the payment (step 420). In another embodiment, risk management engine 104 retries the IFS test a predetermined number of times or until results are received. If IFS results are available, risk management module 104, in one embodiment, evaluates the IFS score against two threshold parameters (see steps 422 and 424). If the IFS score exceeds the fail threshold (step 422), then risk management module 104 vetoes the payment operation. However, if the IFS score merely exceeds the suspect threshold parameter (step 424), a suspect payment operation is executed to flag the payment and the user accounts of the payer and payee associated with the transaction. Assuming that risk management module 104 does not veto the transaction, it grants payment engine permission to transmit a debit clear request on the appropriate transaction processing network to receive the funds which will ultimately be transferred to the payee.

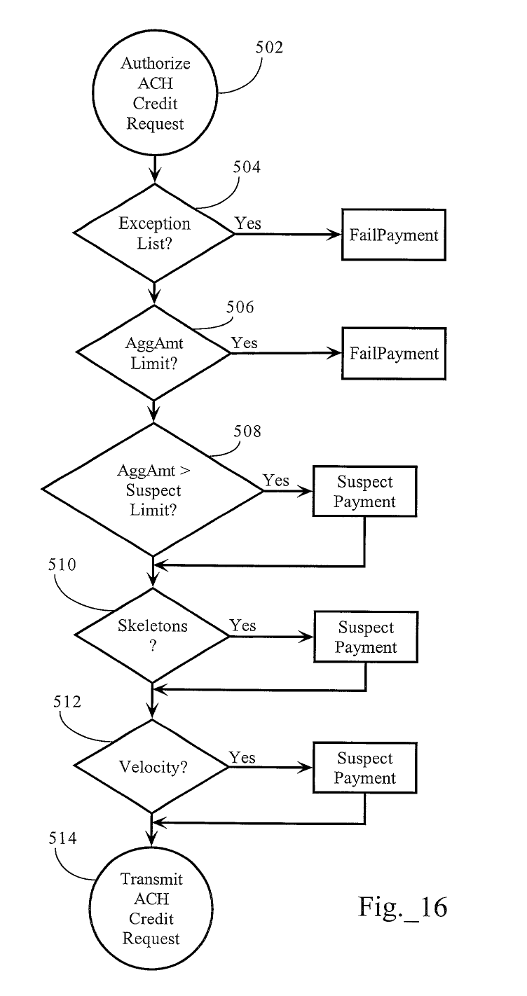

Lastly, FIG. 16 illustrates a method wherein payment engine 106 seeks permission to execute a payment operation that credits the payee's banking account via an ACH credit. In one embodiment, payment engine 106 calls to risk management module 104 to authorize an ACH credit request (step 502). Similar to FIG. 13, risk management engine 104 applies the ExceptionList (step 504), AggAmountLimit (steps 506 and 510), Skeletons (step 510), and Velocity (step 512) tests using the payee's identity. If risk management engine 104 does not veto the payment operation, payment engine 106 transmits a credit request via the ACH network to the payee's bank (step 514).

4. Alternative Exemplary Implementation of Risk Management Module

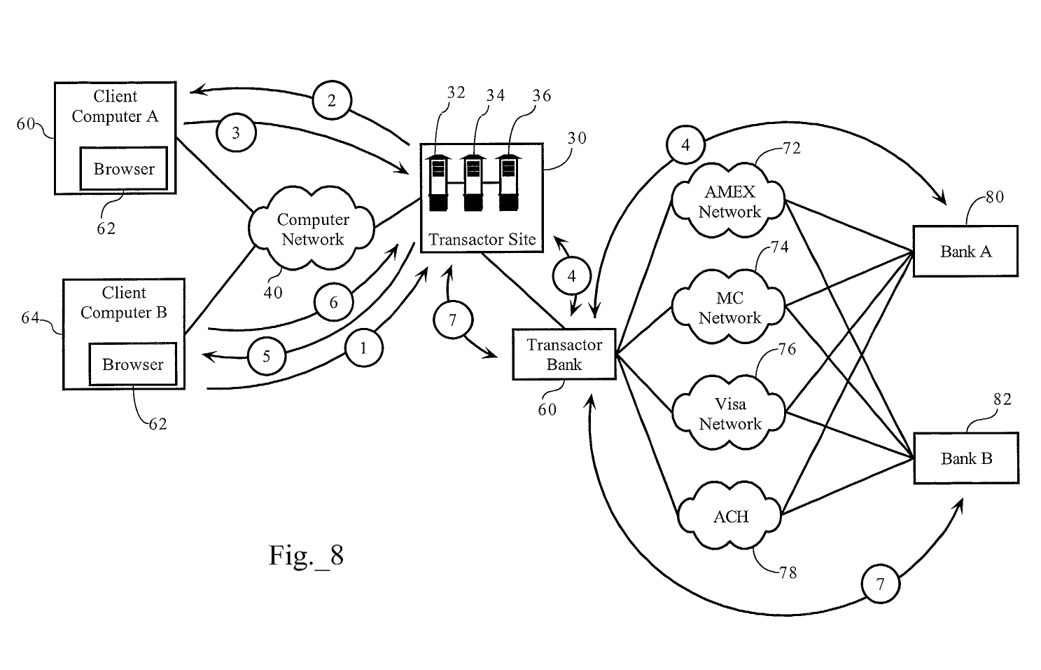

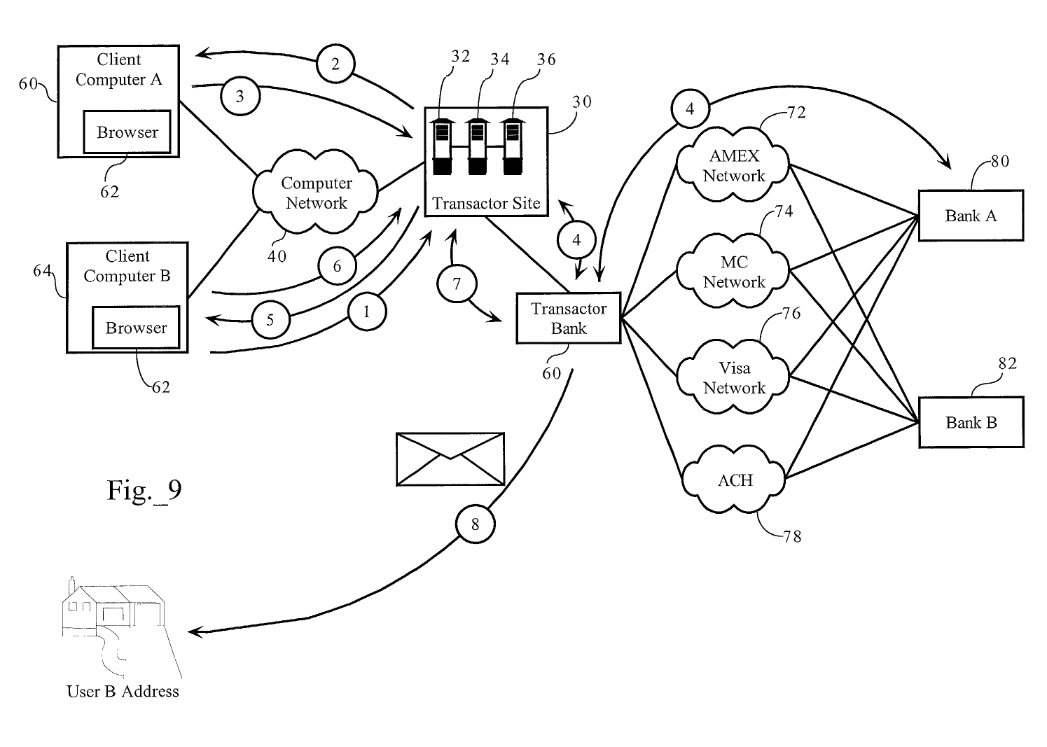

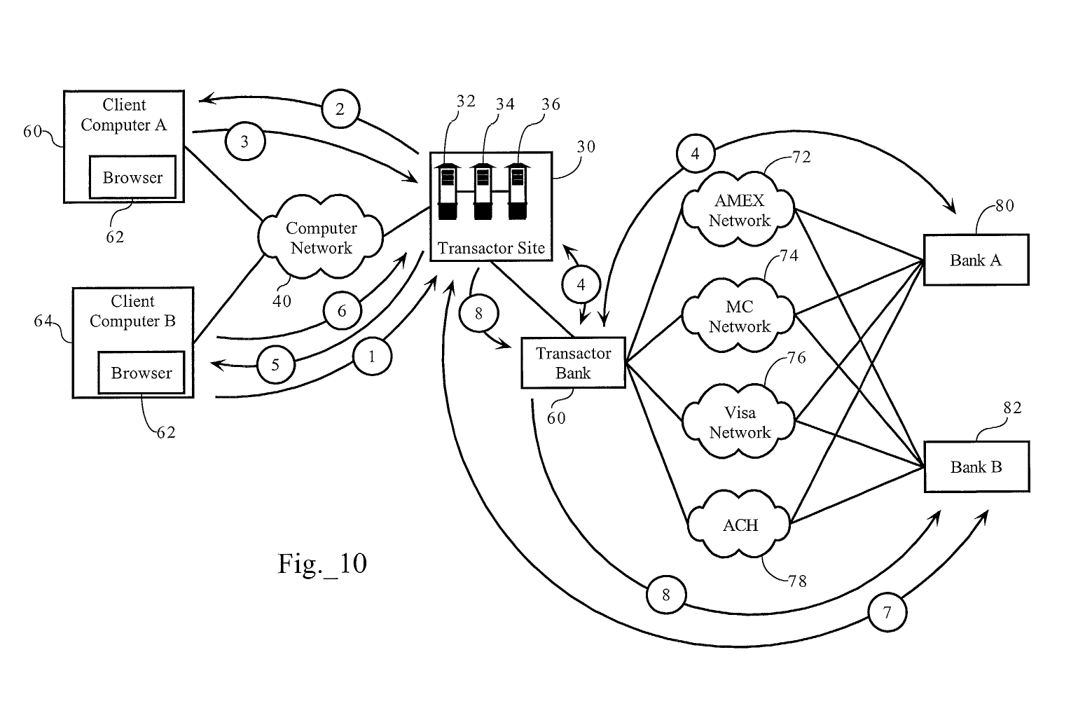

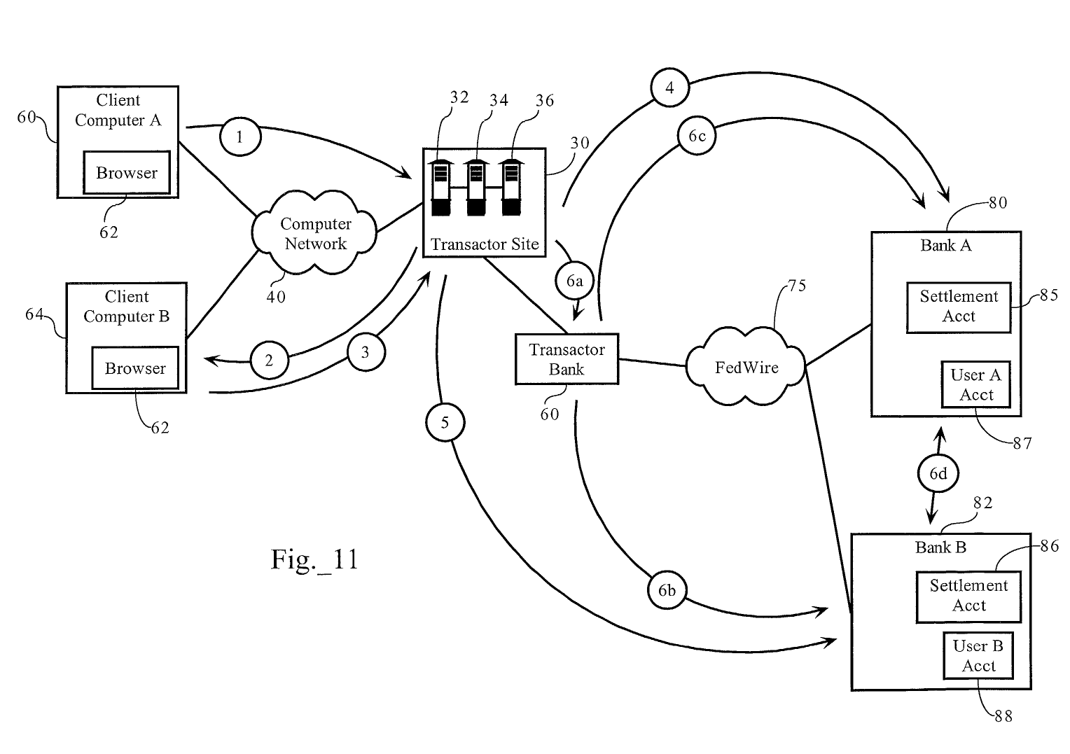

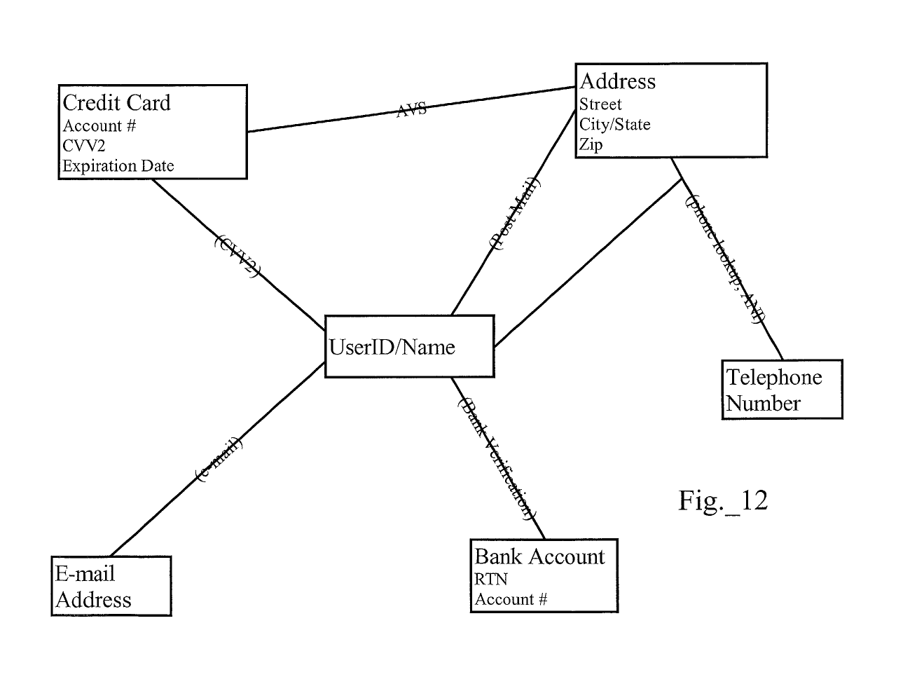

In another embodiment of the present invention, risk management module 104 operates in an alternative mode to verify user data elements. More specifically and in one embodiment, risk management module 104 verifies one or more user data elements in each user record independently from the operation of payment engine 106. FIG. 12 illustrates critical user data elements of one embodiment and the verification mechanisms/trust relationships among them. FIG. 12 also illustrates the mechanisms for verifying one user data element based on knowledge of one or more associated data elements. As FIG. 12 shows, verification mechanisms include, but are not limited to, 1) Address Verification Systems (AVS), 2) Card Validation (CV) systems, 3) e-mail authentication, 4) postal mail authentication, 5) phone lookup systems, 6) Automatic Number Identification (ANI) systems, and 7) Bank Verification Systems. For example, a credit card processing network's address verification system (AVS) allows one to verify a user's address with knowledge of a credit card account data, such as the user's identity and credit card account number. Similarly, use of Card Validation (CV) numbers (e.g., Visa's CVV2 and MasterCard's CVC2) allow for verification that a particular user has physical possession of a particular credit card.

In one form, risk management module 104 applies a set of rules to weight or score associations between elements of user account data. These weighted or scored associations represent or characterize a level of assurance that one data element is accurate based on knowledge of an associated data element. As discussed below, in one embodiment, these weighted associations are based on data gathered during usage of the payment system and/or external checks. In one embodiment, risk management module 104 stores these weighted associations in association with the corresponding user data elements. In one embodiment, risk management module 104, based on the weighted associations, stores permission data operable to allow or disallow further execution of a payment operation involving an associated user data element.

In one embodiment, risk management module 104 verifies user data elements based on knowledge of other user data elements and stores verification information in association with the user data elements. In a repeating cycle, risk management module 104, as to each user record, performs a series of verification checks on data elements based on knowledge of other user data elements associated with the user. In one form, risk management module 104 can verify certain user data elements based on a user's use of the payment system. For example, a user's e-mail can be inherently verified during usage of the system when a user responds to an e-mail notifying the user of a payment. The user's response to the e-mail (e.g., logging in to transactor site 30) sufficient to verify that the recipient e-mail address is properly associated with the user. As to other types of data elements, one embodiment of the present invention employs various mechanisms to verify data elements in each user account. In one embodiment, risk management module 104 employs the RiskTests discussed above to verify various data elements. In one embodiment, risk management module on a periodic basis verifies user data elements in user account database 120 and scores the strength of the verification relationship. In one embodiment, the user records in user account database 120 include elements for each user data element (e.g., name, user identity, e-mail address(es), credit card account number, etc.), as well as verification scores for the data elements and the date the data element was evaluated. In one embodiment, payment engine 106 is configured to access user account database 120 as required for a particular payment operation to retrieve the required data elements and the associated verification scores. In one embodiment, payment engine 106 analyzes the verification values to decide whether to execute the current payment operation. In one form, payment engine 106 cancels a payment operation if a data element critical to the operation possesses a verification score below a threshold level. In another form, payment engine 106 cancels a payment operation if the aggregate verification score for the critical data elements in a particular operation is below a threshold level.

D. Auditing Module

Auditing module 114 validates money transfers and provides separate means of control. In one embodiment, auditing module 114 generates an immutable transaction log providing an audit trail for every payment that describes all actions associated with each payment. Auditing Module 114, in one embodiment, monitors execution of work flows by payment engine 106. In one embodiment, auditing module 114 applies cryptographic techniques to each log message to allow for detection of tampering. Auditing module 114, in one embodiment, must validate a transaction before funds are actually transferred. In one embodiment, auditing module 114 includes a reporting component allowing for the generation of customer service, financial and/or audit reports.

What is claimed is:

1. An apparatus allowing for verification of critical user data elements, comprising
a user account database including at least one user record comprising a first user data element and a second user data element,
wherein at least one verification mechanism exists between the first user data element and the second user data element,
a verification module, wherein the verification module verifies the second user data element based on the first user data element and the verification mechanism between the first user data element and the second user data element.

2. The apparatus of claim 1 wherein usage of the apparatus allows for inherent verification of the first user data element.

3. The apparatus of claim 1 wherein the verification module scores the relationship between the second user data element and the output of the verification mechanism between the first user data element and the second user data element.

4. The apparatus of claim 1 wherein the verification module grants permission to use the second user data element based on evaluation of the output of the verification mechanism between the first user data element and the second user data element.

5. The apparatus of clam 3 grants permission to use the second user data element if the score of the relationship between the second user data element and the output of the verification mechanism between the first user data element and the second user data element exceeds a threshold level.

6. The apparatus of claim 1 further comprising a payment engine including a plurality of payment operations facilitating payments between users; wherein the payment engine accesses the user account database to retrieve user data elements; and wherein the payment engine seeks permission to use the second data element before executing a payment operation.

7. The apparatus of claim 6 wherein the payment engine fails the payment operation if no permission is found.

8. The apparatus of claim 4 wherein the verification module stores permission data associated with the second user data element in the user account database.

9. The apparatus of claim 8 wherein the payment engine access the user account database for the second user data element and the permission data associated with the second user data element.

10. A method for facilitating payments over a computer network, the computer network carrying and routing data between computers connected thereto, the computers including at least one server facilitating payments and at least one client computer associated with one or more users, the method comprising the steps of:
(a) receiving, at the server, a payment request from a first user; wherein the payment request designates a payment amount, a payment source, and an intended recipient;
(b) clearing funds required for the payment request; and,
(c) offering the intended recipient the funds in a pre-paid debit card account.

11. The method of claim 10 wherein the server is operably connected to a plurality of financial institutions via at least one payment transaction processing network; wherein the payment source is a credit/debit card account with one of said financial institutions; and wherein the clearing step (b) comprises the steps of:
(b1) transmitting a debit authorization request over a payment transaction processing network to the financial institution corresponding to the credit card account in the payment request;
(b2) receiving a response to the debit authorization request;
(b3) transmitting a settlement request, if the response indicates approval of the debit authorization request.

12. The method of claim 10 or 11 wherein the offering step (c) comprises the steps of:
(c1) transmitting a payment notification to the intended recipient;
(c2) receiving, from a client computer, a response to the payment notification; and
(c3) transmitting, to the client computer, an offer to receive the payment amount in a prepaid credit/debit card account.

13. The method of claim 10 or 11 further comprising the steps of:
(d) receiving, from a client computer, a response from the intended recipient, the response indicating a selected payment option; and
(e) transmitting a credit card account application form to the client computer, if the intended recipient elects to receive the funds in a prepaid credit card account.

14. The method of claim 13 further comprising the steps of
(f) receiving a completed application form from the intended recipient;
(g) transmitting the completed application form to a financial institution.

15. The method of claim 14 further comprising the steps of
(h) receiving credit card account data from the financial institution, wherein the credit card account data corresponds to a credit card account resulting from the completed application from transmitted in step (g); and
(i) transferring the funds cleared in step (b) to the credit card account.

16. The method of claim 12 further comprising the steps of:
(d) receiving, from the client computer, a response to the offer transmitted in step (c3), the response indicating a selected payment option; and
(e) transmitting, to the client computer, a credit card account application form, if the intended recipient elects to receive the funds in a prepaid credit card account.

17. The method of claim 13 further comprising the steps of
(f) receiving a completed application form from the client computer;
(g) transmitting the completed application form to a financial institution.

18. The method of claim 17 further comprising the steps of
(h) receiving credit card account data from the financial institution, wherein the credit card account data corresponds to a credit card account resulting from the completed application form transmitted in step (g); and
(i) transferring the funds cleared in step (b) to the credit card account.

19. The method of claim 10 wherein the offering step (c) comprises the steps of
(c1) offering the intended recipient electronic wallet services, wherein the electronic wallet services include a financial account with the funds cleared in step (b).

20. A method for facilitating payments over a computer network, the computer network carrying and routing data between computers connected thereto, the computers including at least one server facilitating the payments and at least one client computer associated with one or more users, wherein the server is operably connected to a network association database allowing for resolution of network associations corresponding to users, the network associations indicating the financial institution with which corresponding users are associated, the method comprising the steps of:
(a) receiving, at the server, a payment request from a first user; wherein the payment request designates a payment amount, a payment source, and an intended recipient; wherein the first user is associated with a first financial institution;
(b) clearing funds required for the payment request;
(c) resolving the network association of the intended recipient; and,
(d) offering the intended recipient the funds on a pre-paid financial account with said first financial institution, if the network association of the intended recipient is out-of-network.

21. The method of claim 20 wherein the resolving step (c) comprises the steps of:
(c1) accessing the network association database, the network association database allowing for resolution of the respective network associations of a plurality of users; the network associations indicating the financial institution with which corresponding users are associated.

22. The method of claim 20 wherein the offering step (d) further comprises the steps of:
(d1) offering the intended recipient electronic wallet services branded by the first financial institution, if the network association of the intended recipient is out-of-network; wherein the electronic wallet services include a financial account with the funds cleared in step (b).

23. The method of claim 20, 21, or 22 wherein the financial account is a credit card account.

24. The method of claim 20, 21, or 22 wherein the financial account is a debit card account.

25. The method of claim 20 further comprising the steps of:
(e) receiving, from a client computer, a response from the intended recipient, the response indicating a selected payment option; and
(f) transmitting a financial account application form to the client computer, if the intended recipient elects to receive the funds in a prepaid financial account.

26. The method of claim 25 further comprising the steps of
(g) receiving a completed application form from the intended recipient;
(h) transmitting the completed application form to the first financial institution.

27. The method of claim 26 further comprising the steps of
(i) receiving financial account data from the first financial institution, wherein the financial account data corresponds to a financial account resulting from the completed application form transmitted in step (h); and
(j) transferring the funds cleared in step (b) to the financial account.

28. The method of claim 27 further comprising the step of
(k) packaging the financial account data in an electronic wallet; and
(l) transmitting an electronic wallet client to the intended recipient, the electronic wallet client allowing access to electronic wallet services over the computer network.

29. A method for facilitating payments over a computer network, the computer network carrying and routing data between computers connected thereto, the computers including at least one server facilitating the payments and at least one client computer associated with one or more users, wherein the server is operably connected to a network association database allowing for resolution of network associations corresponding to users, the network associations indicating the financial institution with which corresponding users are associated, the method comprising the steps of:
(a) receiving, at the server, a payment request from a first user; wherein the payment request designates a payment amount, a payment source, and an intended recipient; wherein the first user is associated with a first financial institution;
(b) clearing funds required for the payment request;
(c) resolving the network association of the intended recipient; and,
(d) offering the intended recipient electronic wallet services associated with the first financial institution, if the network association of the intended recipient is out-of-network.

30. A system allowing for payments over a computer network, comprising:
a payment server facilitating payments between users over the computer network;
at least one financial institution server corresponding to a financial institution,
a network association database allowing for resolution of the respective network associations of a plurality of users; the network associations indicating the financial institution with which corresponding users are associated;
at least one network access device associated with at least one user, wherein the network access device is operably connected to the computer network to receive and transmit data;
wherein the financial institution server(s) transmit(s) data over the computer network to the network association database, the data relating to the network associations of users associated with the financial institution;
wherein the payment server receives requests from users at the network access device(s) and accesses the network association database to resolve the network associations of the users;
and wherein the network associations are operable to modify the operation of the payment server relative to the corresponding users.

31. The system of claim 30 wherein the network associations are operable to tailor the services provided to corresponding users by the payment server.

32. The system of claim 30 wherein the network associations are operable to tailor the offers transmitted to corresponding users.

33. The system of claim 30 wherein the network associations are operable to tailor the branding of services provided to users.

34. The system of claim 32 wherein the network associations are operable to tailor the branding of offers transmitted to corresponding users.

35. The system of claim 30 wherein the payment server is associated with an application service provider that hosts a payment application facilitating payments over the computer network for a plurality of client financial institutions;
wherein the payment server receives a payment request associated with a first user designating an intended recipient, a payment amount, and a payment source; wherein the first user is associated with a first financial institution;
wherein the payment server transmits a payment notification to the intended recipient;
wherein the payment server resolves the network association of the intended recipient and tailors the services provided to the intended recipient based on the corresponding network association.

36. A system allowing for payments over a computer network, comprising:
a wallet server that holds and manages financial information corresponding to a plurality of users, wherein the wallet server hosts a payment application facilitating payments between users over the computer network;
at least one financial institution server corresponding to a financial institution; the financial institution server operably connected to the computer network;
a network association database allowing for resolution of the respective network associations of a plurality of users; the network associations indicating the financial institution with which corresponding users are associated; and
at least one network access device associated with at least one user, wherein the network access device is operably connected to the computer network to receive and transmit data; the network access device including a wallet client that, in combination with the wallet server, augments the network access device to facilitate transactions conducted over the computer network;
wherein the financial institution server transmits data over the computer network to the network association database, the data relating to the network associations of users associated with the financial institution;
wherein the wallet server receives payment requests from users at the network access device(s), the payment request designating an intended recipient and a payment amount;
wherein the wallet server accesses the network association database to resolve the network associations of the intended recipient;
and wherein the network associations are operable to modify the operation of the wallet server relative to the corresponding intended recipients.

37. The system of claim 36 wherein the network associations are operable to tailor the branding of notifications provided to intended recipients.

38. The system of claim 36 wherein the network associations are operable to tailor the branding of offers transmitted to intended recipients.

39. The system of clam 36 wherein the network associations are operable to tailor the marketing embedded in the services provided to the intended recipient.

40. A method for facilitating payments over a computer network, the computer network carrying and routing data between computers connected thereto, the computers including at least one server facilitating the payments and at least one client computer associated with one or more users, wherein the payment server is associated with an application service provider to a plurality of client financial institutions, wherein the payment server is operably connected to a network association database allowing for resolution of network associations corresponding to users, the network associations indicating the client financial institution with which corresponding users are associated, the method comprising the steps of:
(a) receiving, at the payment server, a request from a first user, the request including a user identification;
(b) accessing a network association database to retrieve the financial institution associated with the first user;
(c) branding the services provided by the payment server to the first user according to the financial institution associated with the user identification received in step (a);
(d) receiving a payment request from the first user, wherein the payment request designates a payment amount, a payment source, and an intended recipient;
(e) resolving the network association of the intended recipient; and,
(f) tailoring the branding of services provided to the intended recipient based on the network association resolved in step (e).

41. The method of claim 40 wherein the tailoring step (f) comprises the step of:
(f1) transmitting a payment notification to the intended recipient;
(f2) offering the intended recipient electronic wallet services branded with the financial institution associated with the first user, if the network association of the intended recipient is out-of-network.

42. The method of claim 41 wherein the electronic wallet services offered in step (f2) includes a financial account funded with payment amount specified in the payment request.

43. The method of claim 42 wherein the financial account is a debit card account with the financial institution associated with the first user.

44. The method of claim 42 wherein the financial account is a credit card account with the financial institution associated with the first user.

45. An apparatus facilitating payments over a computer network, comprising
a user account database storing user account data associated with a plurality of users for which payment transactions may be processed; the user account data including telephone numbers each associated with a corresponding user;
said apparatus being operable to process payment requests each designating an intended recipient by a telephone number;
said apparatus being operable to transfer funds to the users associated with the telephone numbers in the respective payment requests.

46. The apparatus of claim 45 wherein the apparatus is operable to transmit payment notifications to devices associated with the telephone numbers in the payment requests.

47. The apparatus of claim 46 wherein the payment notifications are transmitted as SMS messages.

48. The apparatus of claim 45 wherein the apparatus transmits data to and receives data from the device associated with telephone number to facilitate funds transfers to intended recipients.

49. The apparatus f claim 45 further comprising an interactive voice response unit allowing intended recipients to interact with said apparatus and select payment options associated with the payment request.

50. An apparatus facilitating payments over a computer network, comprising
a user account database storing user account data associated with a plurality of users for payment transactions may be processed;
said apparatus being operable to process payment requests each designating an intended recipient by a telephone number;
said apparatus being operable to transmit payment notifications to the respective devices associated with the telephone numbers;
said apparatus being operable to transfer funds to the users associated with the telephone numbers in the respective payment requests; and,
wherein said apparatus is operable to register intended recipients and store user account data associated with the intended recipients in the user account database.

51. The apparatus of claim 50 further comprising a interactive voice response unit allowing for registration of intended recipients using the devices associated with the telephone numbers in the payment requests.

52. The apparatus of claim 50 or 51 wherein the apparatus is operable to register an intended recipient during a response to a payment notification.

53. A method facilitating payments between users, the method comprising the steps of:
(a) receiving a payment request from a user, wherein the payment request includes a telephone number associated with the intended recipient;
(b) transmitting a payment notification to the device associated with telephone number in the payment request;
(c) receiving a response to the payment notification transmitted in step (b);
(d) prompting the intended recipient to select a payment option; and
(e) transferring funds to the intended recipient according to the payment option selected by the user.

54. The method of claim 53 wherein the device is a cell phone, and wherein the payment notification comprises a small text message transmitted to the cell phone.

55. The method of claim 53 wherein the device is a GSM-enabled cell phone, and wherein the payment notification is transmitted as an SMS message to the device.

56. The method of claim 53 further comprising the steps of:
(f) scanning a user account database to determine whether the intended recipient is a registered user; and,
(g) registering the intended recipient and storing user account data in the user account database.

57. A method facilitating payments between users, the method comprising the steps of:
(a) receiving a payment request from a user, wherein the payment request includes a telephone number associated with the intended recipient;
(b) scanning a database for a user and financial account data associated with the telephone number in the payment request; and,
(c) transferring funds to a financial account corresponding to the user associated with the telephone number in the payment request.

58. The method of claim 57 further comprising the step of
(d) transmitting a payment notification to the device associated with telephone number in the payment request.

59. A method facilitating payments over a computer network, the computer network comprising a server facilitating payments between users and a user account database including user identifications and entities in association therewith, the method comprising the steps of:
(a) receiving, at a server, a payment pickup request, the payment pickup request including a recipient user identification and a payment identification, wherein a payer user identification is associated with the payment identification;
(b) scanning a user account database to identify an entity associated with the recipient user identification;
(c) if the user account database includes the recipient user identification, transmitting a payment pickup page facilitating receipt of a payment associated with the payment identification; wherein the payment pickup page is branded according to the entity associated with the recipient user identification.

60. The method of claim 59 further comprising the step of
(d) if the user account database does not contain the recipient user identification, transmitting a login form facilitating logging in to a user account; wherein the login form is branded according to the entity associated with the payer user identification corresponding to the payment identification.

61. The method of claim 60 wherein the login form instructs unregistered users to register for an account with the entity associated with the payer user identification.

62. The method of claim 59 wherein the user identification is an email address.

63. The method of claim 59 wherein the entity is a financial institution.
